(19) United States
(12) Patent Application Publication
(10) Pub. No.: US 2007/0177740 A1
(43) Pub. Date: Aug. 2, 2007

(54) ENCRYPTION KEY DISTRIBUTION SYSTEM, KEY DISTRIBUTION SERVER, LOCKING TERMINAL, VIEWING TERMINAL, ENCRYPTION KEY DISTRIBUTION METHOD, AND COMPUTER-READABLE MEDIUM

(76) Inventor: Keiichi Nakajima, Tokyo (JP)

Correspondence Address: STROOCK & STROOCK & LAVAN LLP, 180 MAIDEN LANE, NEW YORK, NY, 10038, US

(21) Appl. No.: 11/697,200

(22) Filed: Apr. 5, 2007

Related U.S. Application Data
(63) Continuation of application No. PCT/JP04/14965, filed on Oct. 8, 2004.

(51) Int. Cl. H04L 9/00

(52) U.S. Cl. 380/277

(57) ABSTRACT

It is aimed to provide an encryption key distribution system which can be easily operated, highly freely share the data therein, and achieve high reliability for authentication of one or more unlocking right owners who are assigned to each encrypted folder. An encryption key distribution system 500 stores a lock used to lock a folder on a PC 100, and stores an unlocking key corresponding to the lock on a key distribution server 200. To view a locked folder (hereinafter referred to as the encrypted folder), a mobile telephone 300 accesses the key distribution server 200, and is authenticated by using authentication data unique to the mobile telephone 300. Under the condition that the authentication is successful, the key distribution server 200 distributes the unlocking key to the PC 100. The PC 100 unlocks the encrypted folder by using the unlocking key distributed from the key distribution server 200, thereby displaying the contents of the folder.

### CROSS REFERENCE TO RELATED APPLICATION

This is a continuation application of PCT/JP2004/014965 filed on Oct. 8, 2004, the contents of which are incorporated herein by reference.

### BACKGROUND

1. TECHNICAL FIELD

The present invention relates to an encryption key distribution system, a key distribution server, a locking terminal, a viewing terminal, an encryption key distribution method, and a computer-readable medium.

2. RELATED ART

A security system has been conventionally provided to achieve the security of secret files. According to a widely-used security system, at present, when a secret file is encrypted, a user ID and a password of a user who is permitted to view the secret file are registered. When someone desires to view the secret file, the security system requests the person to input a user ID and a password, and decrypts the secret file under the condition that the input user ID and password match the registered data. However, such a user ID and a password are at risk of being known to a third person because of insufficient management. Furthermore, when the third person who has illegally acquired the user ID and password attempts to access the secret file, the above security system has no means for judging whether the attempt is illegal.

To solve this problem, a system disclosed in Patent Document 1 includes therein a server, a mobile telephone and a PC storing thereon encrypted contents. When a user desires to decrypt the contents on the PC, the PC inquires the mobile telephone coupled thereto by wired connections about whether the mobile telephone has a key. When having no key, the mobile telephone accesses the server, subjects itself to authentication, acquires the key from the server under the condition that the authentication is successful, and transmits the acquired key to the PC. According to this technique, the user is authenticated with the use of the terminal ID unique to the mobile telephone owned by the user. Consequently, the system disclosed in Patent Document 1 achieves the effects of being capable of preventing a third person from falsely using the user's identity.

[Patent Document 1] Unexamined Japanese Patent Application Publication No. 2003-30157, FIG. 5

According to the technique disclosed in Patent Document 1, however, every time the user attempts to decrypt the encrypted contents, the mobile telephone is required to be connected to the PC and the key needs to be transmitted from the mobile phone to the PC. When the mobile telephone does not have the key, a series of operations are required in such a manner that the mobile telephone accesses the server to get the mobile telephone authenticated, downloads the key thereto from the server, and then finally transmits the key to the PC. Therefore, the technique according to the disclosure of Patent Document 1 requires the user to perform troublesome operations.

### SUMMARY

To solve the above-mentioned problems, a first embodiment of the present invention provides an encryption key distribution system including a locking terminal that stores thereon an encryption key used to encrypt a folder and generates an encrypted folder by encrypting the folder by using the encryption key, a key distribution server that stores thereon, in association with the encryption key, a decryption key used to decrypt the encrypted folder which is encrypted by the locking terminal using the encryption key, a viewing terminal that (i) stores thereon the encrypted folder which is encrypted by the locking terminal using the encryption key, (ii) when receiving a request to view the encrypted folder, transmits the request to view the encrypted folder to the key distribution server, and (iii) when receiving the decryption key corresponding to the encrypted folder from the key distribution server, unlocks the encrypted folder by using the decryption key, and a mobile communication terminal that is registered in the key distribution server as an authentication key used to authenticate a user. Here, when receiving the request to view the encrypted folder from the viewing terminal, the key distribution server transmits the decryption key to the viewing terminal, under a condition that the key distribution server receives an access from the mobile communication terminal owned by the user who is set as an unlocking right owner of the encrypted folder.

The key distribution server may include a decryption key database that stores thereon the decryption key in association with a key ID that identifies a combination of the encryption key and the decryption key, a user database that stores thereon authentication data unique to the mobile communication terminal owned by the user, in association with a user ID of the user, and an authentication section that, when the key distribution server receives the request to view the encrypted folder from the viewing terminal, (i) receives a viewing request including therein (a) the user ID of the unlocking right owner who is entitled to decrypt the encrypted folder and (b) the key ID that identifies the encryption key used to generate the encrypted folder, (ii) acquires an address of the viewing terminal, (iii) reads the authentication data from the user database by using, as a key, the user ID of the unlocking right owner included in the viewing request, and (iv) waits for the access from the mobile communication terminal. Here, when receiving the access from the mobile communication terminal, the authentication section of the key distribution server may (I) receive the authentication data from the mobile communication terminal, (II) compare the authentication data received from the mobile communication terminal with the authentication data read from the user database, (III) successfully authenticate the mobile communication terminal under a condition that the compared pieces of authentication data match each other, (IV) read the decryption key from the decryption key database by using, as a key, the key ID included in the viewing request, under a condition that the authentication of the mobile communication terminal is successful, and (V) transmit the read decryption key to the acquired address of the viewing terminal. The locking terminal may include a locking section that generates the encrypted folder by encrypting the folder by using the encryption key, and writes, into the encrypted folder, (i) the user ID of the unlocking right owner who is entitled to decrypt the encrypted folder and (ii) the key ID that identifies the encryption key used to generate the encrypted folder. The viewing terminal may include a viewing request section that, when the viewing terminal receives the request to view the encrypted folder, establishes a connection with the key distribution server, and transmits, as the viewing request of the encrypted folder, the user ID of the unlocking right owner and the key ID which are written in the encrypted folder, to the key distribution server, and an unlocking section that decrypts the encrypted folder the viewing of which is requested, by using the decryption key received from the key distribution server. When the viewing terminal transmits the request to view the encrypted folder to the key distribution server, the mobile communication terminal may access the key distribution server to transmit the authentication data unique to the mobile communication terminal.

The authentication section of the key distribution server may (i) store, onto the decryption key database, the number of times at which the authentication section transmits the decryption key to the viewing terminal, as the number of unlocking operations based on the decryption key, in association with the key ID, (ii) update the number of unlocking operations based on the decryption key by incrementing the number, every time the authentication section transmits the decryption key to the viewing terminal, and (iii) transmit the number of unlocking operations to the locking terminal in association with the key ID, every time the authentication section updates the number of unlocking operations. The locking terminal may further include a management database that stores thereon, in association with the key ID, the number of unlocking operations based on the decryption key which is received from the key distribution server. When encrypting the folder by using the encryption key, the locking section may (i) read the number of unlocking operations from the management database by using, as a key, the key ID that identifies the encryption key to be used, (ii) modify the encryption key by using the number of unlocking operations which is read from the management database in accordance with a predetermined algorithm, and (iii) encrypt the folder by using the modified encryption key. When reading the decryption key and transmitting the read decryption key to the address of the viewing terminal, the authentication section may (I) read the number of unlocking operations from the decryption key database by using, as a key, the key ID that identifies the decryption key, (II) modify the decryption key by using the read number of unlocking operations in accordance with the same predetermined algorithm used by the locking terminal to modify the encryption key, and (III) transmit the modified decryption key to the address of the viewing terminal. The unlocking section may decrypt the encrypted folder which is generated by encrypting the folder by using the modified encryption key, by using the modified decryption key.

The locking terminal may write, into the single encrypted folder, a plurality of user IDs which identify a plurality of unlocking right owners.

The key distribution server may store, on the user database, an e-mail address of the mobile communication terminal owned by the user, in association with the user ID. When receiving the request to view the encrypted folder, the viewing terminal may (i) request a user to input a user ID, and (ii) when the user inputs the user ID, further transmit, to the key distribution server, a different user ID than the user ID input into the viewing terminal, which is selected from the plurality of user IDs which are written in the encrypted folder to identify the plurality of unlocking right owners for the encrypted folder, under a condition that the input user ID is included in the plurality of user IDs written in the encrypted folder. When successfully authenticating the user identified by the user ID input into the viewing terminal as the unlocking right owner of the encrypted folder, the key distribution server may read an e-mail address of a mobile communication terminal from the user database by using, as a key, the different user ID than the user ID input into the viewing terminal which is selected from the plurality of user IDs written in the encrypted folder, and send an e-mail, to the read e-mail address, informing that the decryption key to decrypt the encrypted folder is distributed.

The key distribution server may store, on the user database, an e-mail address of the mobile communication terminal owned by the user, in association with the user ID. When receiving the request to view the encrypted folder, the viewing terminal may (i) request a user to input a user ID, and (ii) when the user inputs the user ID, transmit the input user ID to the key distribution server, under a condition that the input user ID is included in the user ID which is written in the encrypted folder to identify the unlocking right owner for the encrypted folder. The key distribution server may read the e-mail address of the mobile communication terminal owned by the user from the user database by using, as a key, the user ID input into the viewing terminal, and send an e-mail, to the read e-mail address, including a message informing that a necessary procedure is required to be performed to authenticate the user of the mobile communication terminal as the unlocking right owner of the encrypted folder.

When receiving the request to view the encrypted folder, the viewing terminal may request a user to input a user ID, and transmit the input user ID and the viewing request of the encrypted folder, to the key distribution server. When receiving, from the viewing terminal, the viewing request of the encrypted folder and the user ID input into the viewing terminal, the key distribution server may acquire a terminal ID that identifies the viewing terminal from the viewing terminal, and store, onto the decryption key database, in association with the key ID written in the encrypted folder, a date and a time of receiving the viewing request from the viewing terminal, the terminal ID of the viewing terminal, the user ID input into the viewing terminal, and a result of the authentication of the user who accesses the key distribution server with the mobile communication terminal.

The key distribution server may store, on the user database, an e-mail address of the user in association with the user ID. When the authentication of the mobile communication terminal is unsuccessful, the key distribution server may read the e-mail address of the unlocking right owner from the user database by using, as a key, the user ID of the unlocking right owner written in the encrypted folder viewing of which is requested, and send a message, to the read e-mail address, informing that the viewing request is issued but the authentication is unsuccessful.

The locking section may write an address of the key distribution server into the encrypted folder, and the viewing request section may establish the connection with the key distribution server based on the address written in the encrypted folder.

The key distribution server may store, on the user database, an e-mail address of the mobile communication terminal owned by the user in association with the user ID. When writing the user ID of the unlocking right owner for the encrypted folder into the encrypted folder, the locking terminal may transmit the user ID of the unlocking right owner to the key distribution server. The key distribution server may read the e-mail address of the mobile communication terminal owned by the user from the user database by using, as a key, the user ID received from the locking terminal, and send an e-mail, to the e-mail address of the mobile communication terminal which is read from the user database, informing that the user ID received from the locking terminal is set as the user ID of the unlocking right owner for the encrypted folder.

The key distribution server may send a message, to the locking terminal, informing that the key distribution server permits the user ID received from the locking terminal to be set as the user ID of the unlocking right owner for the encrypted folder, under a condition that the key distribution server receives a replay e-mail from the e-mail address within a predetermined time limit from a timing of sending the e-mail. The locking terminal may set the user ID transmitted to the key distribution server as the user ID of the unlocking right owner for the encrypted folder, under a condition that the locking terminal receives the message informing the permission from the key distribution server.

The key distribution server may provide a download website for an application program which causes the mobile communication terminal to realize a function of accessing the key distribution server and a function of transmitting the authentication data to the key distribution server, and further include an address of the download website in the e-mail sent to the e-mail address of the mobile communication terminal.

The key distribution server may store, on the user database, an e-mail address of the user in association with the user ID. When writing the user ID of the unlocking right owner for the encrypted folder into the encrypted folder, the locking terminal may transmit the user ID of the unlocking right owner to the key distribution server. The key distribution server may (i) read the e-mail address of the user from the user database by using, as a key, the user ID received from the locking terminal, (ii) create a website for the user to decide whether to be registered as the unlocking right owner of the encrypted folder, (iii) send an e-mail including therein an address of the created website, to the e-mail address read from the user database, and (iv) send a message, to the locking terminal, informing that the key distribution server permits the user ID received from the locking terminal to be set as the user ID of the unlocking right owner for the encrypted folder, under a condition that the key distribution server detects, on the created website, input of the decision to be registered as the unlocking right owner within a predetermined time limit from a timing of sending the e-mail. The locking terminal may set the user ID transmitted to the key distribution server as the user ID of the unlocking right owner for the encrypted folder, under a condition that the locking terminal receives the message informing the permission from the key distribution server.

The key distribution server may (i) provide a download website for an application program which causes the mobile communication terminal to realize a function of accessing the key distribution server and a function of transmitting the authentication data to the key distribution server, (ii) when receiving the viewing request of the encrypted folder from the viewing terminal, read the e-mail address of the mobile communication terminal owned by the unlocking right owner from the user database by using, as a key, the user ID of the unlocking right owner which is included in the viewing request, and (iii) send an e-mail, to the read e-mail address, including therein a message informing that a necessary procedure is required to be performed to authenticate the user of the mobile communication terminal as the unlocking right owner of the encrypted folder and an address of the download website.

A second embodiment of the present invention provides a key distribution server for distributing a decryption key used to decrypt an encrypted folder that is generated by a locking terminal, to a viewing terminal that decrypts the encrypted folder. Here, when receiving a viewing request of the encrypted folder from the viewing terminal, the key distribution server waits for receiving an access from a mobile communication terminal of a user who is set as an unlocking right owner who is entitled to decrypt the encrypted folder and transmits the decryption key to the viewing terminal under a condition that the key distribution server successfully authenticates the mobile communication terminal.

The key distribution server may include a decryption key database that stores thereon the decryption key in association with a key ID that identifies a combination of an encryption key used to encrypt a folder to generate the encrypted folder and the decryption key used to decrypt the encrypted folder which is generated by using the encryption key.

The key distribution server may include a user database that stores thereon authentication data unique to the mobile communication terminal which accesses the key distribution server, in association with a user ID of the user of the mobile communication terminal.

The key distribution server may include an authentication section that (i) when the key distribution server receives the viewing request of the encrypted folder from the viewing terminal, identifies authentication data unique to the mobile communication terminal owned by the unlocking right owner, based on a user ID of the unlocking right owner, wherein the user ID is included in the viewing request, and (ii) when the key distribution server receives the access from the mobile communication terminal, transmits the decryption key to the viewing terminal, under a condition that the authentication section successfully authenticates the mobile communication terminal based on authentication data received from the mobile communication terminal.

The key distribution server may include a decryption key database that stores thereon the decryption key in association with a key ID that identifies a combination of an encryption key used to encrypt a folder to generate the encrypted folder and the decryption key used to decrypt the encrypted folder which is generated by using the encryption key, a user database that stores thereon authentication data unique to the mobile communication terminal which accesses the key distribution server, in association with a user ID of the user of the mobile communication terminal, and an authentication section that (i) when the key distribution server receives the viewing request of the encrypted folder from the viewing terminal, acquires an address of the viewing terminal, (ii) reads the authentication data from the user database, by using, as a key, the user ID of the unlocking right owner who is entitled to decrypt the encrypted folder, wherein the user ID is included in the viewing request, (iii) waits for an access from the mobile communication terminal, (iv) when receiving the access from the mobile communication terminal, receives the authentication data from the mobile communication terminal, (v) compares the authentication data received from the mobile communication terminal with the authentication data read from the user database, (vi) successfully authenticates the mobile communication terminal under a condition that the compared pieces of authentication data match each other, (vii) reads the decryption key from the decryption key database by using, as a key, the key ID that identifies the encryption key used to generate the encrypted folder, wherein the key ID is included in the viewing request, under a condition that the authentication of the mobile communication terminal is successful, and (viii) transmits the read decryption key to the address of the viewing terminal.

A third embodiment of the present invention provides a locking terminal for generating an encrypted folder by encrypting a folder. The locking terminal includes a locking section that, when the locking terminal generates the encrypted folder by encrypting the folder by using an encryption key, writes a user ID of an unlocking right owner who is entitled to decrypt the encrypted folder and a key ID that identifies the encryption key used to generate the encrypted folder, into the encrypted folder.

A fourth embodiment of the present invention provides a viewing terminal for unlocking an encrypted folder which is generated by encrypting a folder by using an encryption key. The viewing terminal includes a viewing request section that, when the viewing terminal receives a request to view the encrypted folder, reads (i) a user ID of an unlocking right owner who is entitled to decrypt the encrypted folder, (ii) a key ID that identifies the encryption key used to generate the encrypted folder, and (iii) an address of a key distribution server that stores thereon a decryption key corresponding to the key ID, from the encrypted folder, and transmits the read user ID and key ID, to the address of the key distribution server as a viewing request of the encrypted folder, and an unlocking section that, when receiving the decryption key from the key distribution server, decrypts the encrypted folder the viewing of which is requested, by using the decryption key received from the key distribution server.

A fifth embodiment of the present invention provides a locking terminal for generating an encrypted folder by encrypting a folder, and decrypting the encrypted folder by using a decryption key received from a key distribution server. The locking terminal includes a locking section that stores thereon an encryption key used to encrypt the folder, and when generating the encrypted folder by encrypting the folder by using the encryption key, writes a user ID of an unlocking right owner who is entitled to decrypt the encrypted folder and a key ID that identifies the encryption key used to encrypt the folder, into the encrypted folder, a viewing request section that, when the locking terminal receives a request to view the encrypted folder, reads (i) the user ID of the unlocking right owner who is entitled to decrypt the encrypted folder, (ii) the key ID that identifies the encryption key used to generate the encrypted folder, and (iii) an address of the key distribution server that stores thereon the decryption key corresponding to the key ID, from the encrypted folder, and transmits the read user ID and key ID, to the address of the key distribution server as a viewing request of the encrypted folder, and an unlocking section, when the locking terminal receives the decryption key from the key distribution server, decrypts the encrypted folder the viewing of which is requested, by using the decryption key received from the key distribution server.

A sixth embodiment of the present invention provides an encryption key distribution method for distributing an encryption key by using a system including therein (i) a locking terminal that stores thereon an encryption key used to encrypt a folder, (ii) a key distribution server that stores thereon, in association with the encryption key, a decryption key used to decrypt the encrypted folder which is generated by using the encryption key, (iii) a viewing terminal that unlocks the encrypted folder, and (iv) a mobile communication terminal that is registered on the key distribution server as an authentication key used to authenticate a user. According to the encryption key distribution method, the locking terminal generates the encrypted folder by encrypting the folder by using the encryption key, when receiving a request to view the encrypted folder, the viewing terminal transmits a viewing request of the encrypted folder to the key distribution server, when receiving the viewing request of the encrypted folder from the viewing terminal, the key distribution server transmits the decryption key to the viewing terminal, under a condition that the key distribution server receives an access from the mobile communication terminal owned by the user who is set as an unlocking right owner of the encrypted folder, and when receiving the decryption key corresponding to the encrypted folder the viewing of which is requested from the key distribution server, the viewing terminal unlocks the encrypted folder by using the decryption key.

According to the encryption key distribution method described above, the key distribution server may store (i) on a decryption key database, the decryption key in association with a key ID that identifies a combination of the encryption key used to encrypt the folder and the decryption key used to decrypt the encrypted folder generated by using the encryption key, and (ii) on a user database, authentication data unique to the mobile communication terminal which accesses the key distribution server, in association with a user ID of the user of the mobile communication terminal. The locking terminal may encrypt the folder to generate the encrypted folder, and write a user ID of the unlocking right owner who is entitled to decrypt the encrypted folder and the key ID that identifies the encryption key used to generate the encrypted folder, into the encrypted folder. When receiving the request to view the encrypted folder, the viewing terminal may establish a connection with the key distribution server, and transmit, as the viewing request of the encrypted folder, the user ID of the unlocking right owner and the key ID which are written in the encrypted folder, to the key distribution server. When receiving the viewing request of the encrypted folder from the viewing terminal, the key distribution server may (i) acquire an address of the viewing terminal, (ii) read the authentication data from the user database by using, as a key, the user ID of the unlocking right owner included in the viewing request, and (iii) wait for the access from the mobile communication terminal. The mobile communication terminal may access the key distribution server and transmit the authentication data to the key distribution server. When receiving the access from the mobile communication terminal, the key distribution server may (I) receive the authentication data from the mobile communication terminal, (II) compare the authentication data received from the mobile communication terminal with the authentication data read from the user database, (III) successfully authenticate the mobile communication terminal under a condition that the compared pieces of authentication data match each other, (IV) read the decryption key from the decryption key database by using, as a key, the key ID included in the viewing request, under a condition that the authentication of the mobile communication terminal is successful, and (V) transmit the read decryption key to the address of the viewing terminal. The viewing terminal may decrypt the encrypted folder the viewing of which is requested, by using the decryption key received from the key distribution server.

A seventh embodiment of the present invention provides a computer-readable medium storing thereon a program for a key distribution server for distributing a decryption key used to decrypt an encrypted folder that is generated by a locking terminal, to a viewing terminal that decrypts the encrypted folder. The program causes the key distribution server to realize an authentication function of, when the key distribution server receives a viewing request of the encrypted folder from the viewing terminal, waiting for receiving an access from a mobile communication terminal of an unlocking right owner who is entitled to decrypt the encrypted folder and transmitting the decryption key to the viewing terminal under a condition that the key distribution server successfully authenticates the mobile communication terminal.

The program may cause the key distribution server to further realize a decryption key managing function of storing the decryption key in association with a key ID that identifies a combination of an encryption key used to encrypt a folder to generate the encrypted folder and the decryption key used to decrypt the encrypted folder which is generated by using the encryption key, and a user managing function of storing authentication data unique to the mobile communication terminal which accesses the key distribution server, in association with a user ID of the user of the mobile communication terminal. Here, the authentication function may include a function of (i) when the key distribution server receives the viewing request of the encrypted folder from the viewing terminal, acquiring an address of the viewing terminal, (ii) reading the authentication data, by using, as a key, the user ID of the unlocking right owner who is entitled to decrypt the encrypted folder, wherein the user ID is included in the viewing request, (iii) waiting for an access from the mobile communication terminal, (iv) when the key distribution server receives the access from the mobile communication terminal, receiving the authentication data from the mobile communication terminal, (v) comparing the authentication data received from the mobile communication terminal with the read authentication data, (vi) successfully authenticating the mobile communication terminal under a condition that the compared pieces of authentication data match each other, (vii) reading the decryption key by using, as a key, the key ID that identifies the encryption key used to generate the encrypted folder, wherein the key ID is included in the viewing request, under a condition that the authentication of the mobile communication terminal is successful, and (viii) transmitting the read decryption key to the address of the viewing terminal.

An eighth embodiment of the present invention provides a computer-readable medium storing thereon a program for a locking terminal for generating an encrypted folder by encrypting a folder. The program causes the locking terminal to realize a locking function of, when the locking terminal generates the encrypted folder by encrypting the folder by using an encryption key, writing a user ID of an unlocking right owner who is entitled to decrypt the encrypted folder and a key ID that identifies the encryption key used to generate the encrypted folder, into the encrypted folder.

A ninth embodiment of the present invention provides a computer-readable medium storing thereon a program for a viewing terminal for unlocking an encrypted folder which is generated by encrypting a folder by using an encryption key. The program causes the viewing terminal to realize a viewing request function of, when the viewing terminal receives a request to view the encrypted folder, reading (i) a user ID of an unlocking right owner who is entitled to decrypt the encrypted folder, (ii) a key ID that identifies the encryption key used to generate the encrypted folder, and (iii) an address of a key distribution server that stores thereon a decryption key corresponding to the key ID, from the encrypted folder, and transmitting the read user ID and key ID, to the address of the key distribution server as a viewing request of the encrypted folder.

A tenth embodiment of the present invention provides a computer-readable medium storing thereon a program for a locking terminal for generating an encrypted folder by encrypting a folder, receiving a decryption key used to decrypt the encrypted folder from a key distribution server, and decrypting the encrypted folder by using the decryption key. The program causes the locking terminal to realize a locking function of storing an encryption key used to encrypt the folder, and when the locking terminal generates the encrypted folder by encrypting the folder by using the encryption key, writing a user ID of an unlocking right owner who is entitled to decrypt the encrypted folder and a key ID that identifies the encryption key used to encrypt the folder, into the encrypted folder, a viewing request function of, when the locking terminal receives a request to view the encrypted folder, reading (i) the user ID of the unlocking right owner who is entitled to decrypt the encrypted folder, (ii) the key ID that identifies the encryption key used to generate the encrypted folder, and (iii) an address of the key distribution server that stores thereon the decryption key corresponding to the key ID, from the encrypted folder, and transmitting the read user ID and key ID, to the address of the key distribution server as a viewing request of the encrypted folder, and an unlocking function of, when the locking terminal receives the decryption key from the key distribution server, decrypting the encrypted folder the viewing of which is requested, by using the decryption key received from the key distribution server.

Here, all the necessary features of the present invention are not listed in the summary. The sub-combinations of the features may become the invention.

### BRIEF DESCRIPTION OF THE DRAWINGS

FIG. 1 illustrates an exemplary configuration of an encryption key distribution system 500.

FIG. 2 illustrates one example of a lock window 122 displayed by a locking section 110.

FIG. 3 illustrates one example of a common setting window 34 for setting an unlocking right owner.

FIG. 4 illustrates one example of data stored on a user database 220.

FIG. 5 illustrates one example of data stored on an unlocking key database 230.

FIG. 6 illustrates one example of data stored on a management database 130.

FIG. 7 illustrates one example of data recorded in an encrypted folder.

FIG. 8A illustrates screen transition of a PC 100 and a mobile telephone 300 which is seen when an authentication section 210 attempts to authenticate the mobile telephone 300.

FIG. 8B illustrates the screen transition of the PC 100 and the mobile telephone 300 which is seen when the authentication section 210 attempts to authenticate the mobile telephone 300.

FIG. 9A illustrates an exemplary sequence of processes which are performed when the encryption key distribution system 500 registers a new combination of a lock and an unlocking key.

FIG. 9B illustrates the exemplary sequence of processes which are performed when the encryption key distribution system 500 registers the new combination of a lock and an unlocking key.

FIG. 10A illustrates an exemplary sequence of processes which are performed when the encryption key distribution system 500 unlocks an encrypted folder.

FIG. 10B illustrates the exemplary sequence of processes which are performed when the encryption key distribution system 500 unlocks the encrypted folder.

### DESCRIPTION OF EXEMPLARY EMBODIMENTS

Hereinafter, one aspect of the present invention will be described through some embodiments. The embodiments do not limit the invention according to the claims, and all the combinations of the features described in the embodiments are not necessarily essential to means provided by aspects of the invention.

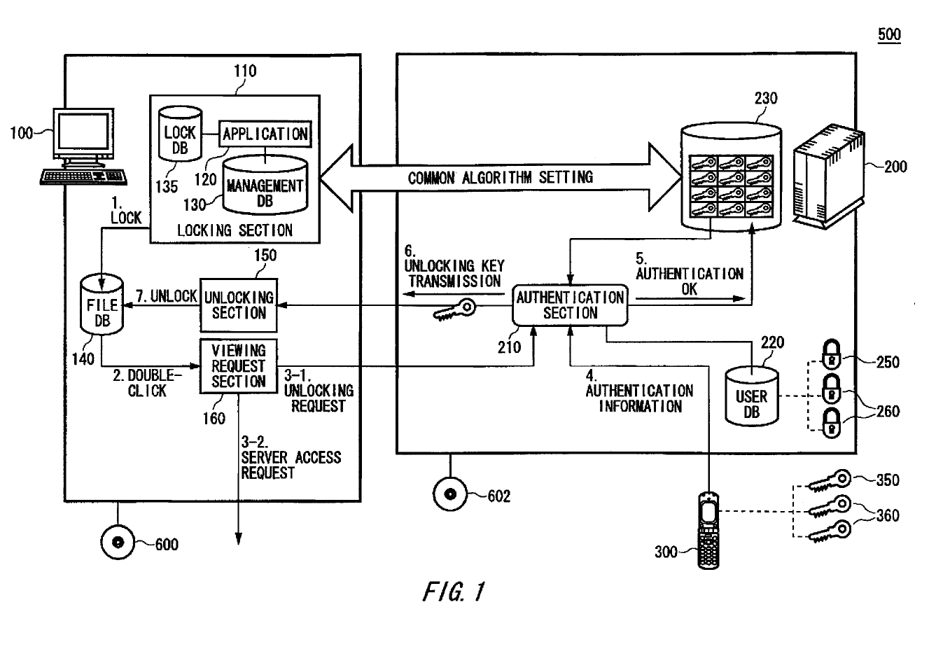

FIG. 1 illustrates an exemplary configuration of an encryption key distribution system 500. The encryption key distribution system 500 relating to the present embodiment includes therein a PC 100, a key distribution server 200 and a mobile telephone 300. In the encryption key distribution system 500, the PC 100 stores thereon locks used to encrypt folders (hereinafter referred to as “to lock the folders”), and the key distribution server 200 stores thereon unlocking keys corresponding to the locks. To view a locked folder (hereinafter referred to as “an encrypted folder”), a user accesses the key distribution server 200 by using the mobile telephone 300, and the key distribution server 200 authenticates the mobile telephone 300 based on authentication data unique to the mobile telephone 300. Under the condition that the authentication is successful, the key distribution server 200 distributes an unlocking key to the PC 100. The PC 100 decrypts the encrypted folder (hereinafter referred to as “to unlock the encrypted folder”) with the use of the unlocking key distributed by the key distribution server 200, so as to display the contents of the folder.

As described above, the authentication necessary to unlock the encrypted folder stored on the PC 100 is performed by using the authentication data unique to the mobile telephone 300 which is separately provided from the PC 100. Therefore, the unlocking of the encrypted folder can be more reliably permitted only to limited users based on a simple authentication procedure. Here, the PC 100 is shown as an example of a locking terminal and a viewing terminal relating to the present invention. The viewing terminal relating to the present invention is an information processing terminal for unlocking the encrypted folder. The viewing terminal may be configured by the same information processing terminal as the locking terminal, or separately provided from the locking terminal. The mobile telephone 300 is shown as one example of a mobile communication terminal relating to the present invention. Apart from the mobile telephone 300, the mobile communication terminal relating to the present invention may be a PHS or one of a personal digital assistant (PDA) and a laptop PC including therein a wireless communication section such as the wireless LAN.

The PC 100 includes therein a file database 140, a locking section 110, an unlocking section 150, and a viewing request section 160. The file database 140 stores thereon files and file folders. The locking section 110 includes therein a lock database 135, a management database 130, and an application section 120. The lock database 135 stores thereon locks used to lock folders. The management database 130 collectively stores thereon attribution information of the locks stored on the lock database 135. The application section 120 generates an encrypted folder by locking a folder red from the file database 140 with the use of a lock read from the lock database 135. Here, the application section 120 writes, into the encrypted folder, a user ID identifying an unlocking right owner who is entitled to unlock the encrypted folder and a key ID identifying the lock used to generate the encrypted folder. The application section 120 stores, onto the file database 140, the encrypted folder into which the user ID identifying the unlocking right owner and the key ID are written.

The viewing request section 160 establishes a connection with the key distribution server 200, when the PC 100 receives a request to view the encrypted folder, and transmits, as a viewing request of the encrypted folder, the user ID of the unlocking right owner and the key ID written in the encrypted folder, to the key distribution server 200.

The key distribution server 200 includes therein an unlocking key database 230 and a user database 220. The unlocking key database 230 stores thereon unlocking keys used to unlock encrypted folders which are locked by using the locks stored on the PC 100, in association with the locks stored on the PC 100. For example, the unlocking key database 230 stores thereon the unlocking keys used to unlock the encrypted folders which are locked by using the locks, in association with key IDs identifying combinations of a lock and an unlocking key. In the following description, a group of unlocking keys stored on the unlocking key database 230 in association with the same PC 100 is referred to as a key library. The user database 220 stores thereon terminal authentication data 250 unique to the mobile telephone 300 owned by a user in association with the user ID of the user. The terminal authentication data 250 unique to the mobile telephone 300 is, for example, a MAC address of the mobile telephone 300. The user database 220 may also store thereon additional authentication data 260 in association with the user ID. The additional authentication data 260 is authentication data which is requested by an authentication section 210 to authenticate the mobile telephone 300 in addition to the terminal authentication data 250. The additional authentication data 260 is, for example, a PIN number, voice print data, fingerprint data, and a combination of a question and an answer which is related to interaction authentication.

The key distribution server 200 further includes therein the authentication section 210. When the key distribution server 200 receives the viewing request of the encrypted folder from the PC 100, the authentication section 210 acquires the address of the PC 100, reads the terminal authentication data 250 from the user database 220 by using, as a key, the user ID of the unlocking right owner included in the viewing request, and waits for an access by the mobile telephone 300. The mobile telephone 300 accesses the key distribution server 200 and transmits to the key distribution server 200 terminal authentication data 350 such as a MAC address.

When receiving the access by the mobile telephone 300, the authentication section 210 receives the terminal authentication data 350 from the mobile telephone 300, compares the terminal authentication data 350 with the terminal authentication data 250 read from the user database 220, and successfully authenticates the mobile telephone 300 under the condition that the compared pieces of authentication data 250 and 350 match each other. When the viewing request of the encrypted folder requires additional authentication, the authentication section 210 reads, from the user database 220, the additional authentication data 260 corresponding to one or more required additional authentication items by using as a key, the user ID of the unlocking right owner included in the viewing request. Furthermore, the authentication section 210 requests the mobile telephone 300 to transmit the additional authentication data 360 corresponding to the additional authentication items required for the encrypted folder. The mobile telephone 300 transmits the additional authentication data 360 input by the user to the authentication section 210. The authentication section 210 compares the additional authentication data 360 received from the mobile telephone 300 with the additional authentication data 260 read from the user database 220, and successfully authenticates the mobile telephone 300 under the condition that the compared pieces of authentication data 260 and 360 match each other.

Under the condition that the authentication of the mobile telephone 300 is successful, the authentication section 210 reads an unlocking key from the unlocking key database 230 by using as a key the key ID included in the viewing request, and transmits the read unlocking key to the address of the PC 100.

The unlocking section 150 of the PC 100 receives the unlocking key from the key distribution server 200, and unlocks the encrypted folder the viewing of which is requested with the use of the received unlocking key. In this manner, an original folder is displayed. The unlocking section 150 stores the unlocked folder onto the file database 140.

Here, the authentication section 210 stores, onto the unlocking key database 230, the number of times at which the authentication section 210 transmits the unlocking key to the PC 100, as the number of unlocking operations based on the unlocking key, in association with the key ID. The authentication section 210 updates the number of unlocking operations based on the unlocking key by incrementing the number, every time the authentication section 210 transmits the unlocking key to the PC 100. Every time the authentication section 210 updates the number of unlocking operations stored on the unlocking key database 230, the authentication section 210 transmits the number to the PC 100 in association with the key ID. The PC 100 stores the number of unlocking operations based on the unlocking key which is received from the key distribution server 200, onto the management database 130 in association with the key ID. Here, when locking a folder by using a lock, the locking section 110 reads the number of unlocking operations from the management database 130 by using, as a key, a key ID which identifies the lock to be used for the locking, modifies the lock with the use of the read number of unlocking operations in accordance with a predetermined algorithm, and locks the folder by using the modified lock.

When transmitting an unlocking key which is read from the unlocking key database 230 to the address of the PC 100, the authentication section 210 reads the number of unlocking operations from the unlocking key database 230 by using, as a key, a key ID which identifies the unlocking key. The authentication section 210 modifies the unlocking key by using the number of unlocking operations which is read from the unlocking key database 230 in accordance with the same algorithm as the algorithm used by the locking section 110 to modify a lock, and transmits the modified unlocking key to the address of the PC 100. As described above, the encryption key distribution system 500 modifies the lock and unlocking key by using the number of unlocking operations, which is updated every time the unlocking key is issued. With this configuration, the encryption key distribution system 500 can prevent an illegal activity where the data of a previously used key is duplicated and used to illegally unlock encrypted files.

A recording medium 600 stores thereon a program to cause the PC 100 to realize the functions of the locking section 110, file database 140, unlocking section 150, and viewing request section 160. The PC 100 reads the program from the recording medium 600 and installs the program therein. The PC 100 may acquire the program via a network and install the program therein.

A recording medium 602 stores thereon a program to cause the key distribution server 200 to realize the functions of the unlocking key database 230, authentication section 210, and user database 220. The key distribution server 200 reads the program from the recording medium 602, and installs the program therein. The key distribution server 200 may acquire the program via a network and install the program therein.

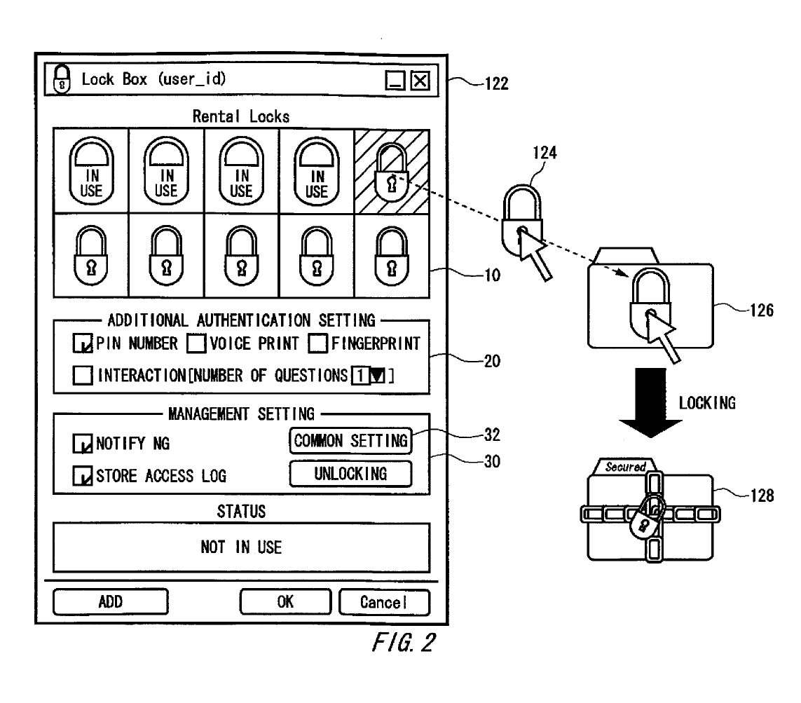

FIG. 2 illustrates one example of a lock window 122 displayed by the locking section 110. The lock window 122 includes therein a lock list 10, an additional authentication setting section 20, and a management setting section 30. The lock list 10 displays locks in such a manner that the locks that are currently used and the locks that are not currently used are distinguishable from each other. Each of the lock icons displayed on the lock list 10 is associated with a corresponding one of the locks stored on the lock database 135. To lock a secret folder 126, a user drags an icon 124 of a lock that is not currently used, and drops the lock icon 124 onto the secret folder 126 to be locked. In accordance with the user's operation, the locking section 110 reads a lock corresponding to the lock icon 124 from the lock database 135, and locks the secret folder 126 with the use of the read lock, thereby generating an encrypted folder 128.

The additional authentication setting section 20 sets an additional authentication item to be requested by the authentication section 210 to authenticate the mobile telephone 300, in addition to the authentication information unique to the mobile telephone 300. For example, the additional authentication item is a PIN number, voice print, fingerprint and/or interaction. The management setting section 30 includes a common setting button 32. The common setting button 32 is used to open a common setting window 34 for setting an unlocking right owner of the encrypted folder 128.

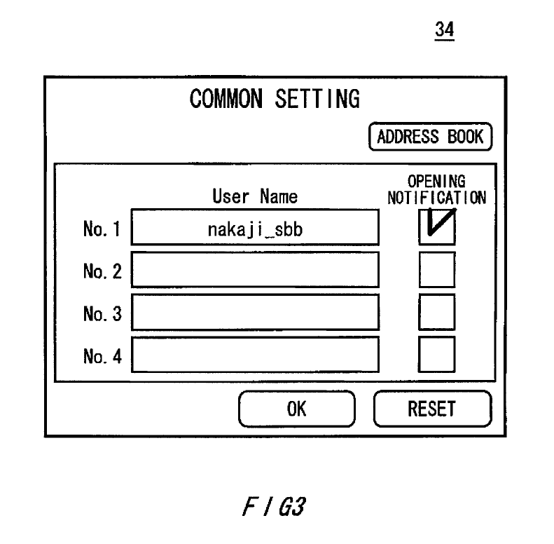

FIG. 3 illustrates one example of the common setting window 34 for setting the unlocking right owner of the encrypted folder 128. The common setting window 34 includes input fields to be used to input user IDs of a plurality of unlocking right owners for a single encrypted folder. The user inputs at least one user ID to identify an unlocking right owner of the encrypted folder 128 via the common setting window 34. The locking section 110 writes one or more user IDs input via the common setting window 34 into the encrypted folder 128, as the user IDs identifying unlocking right owners of the encrypted folder 128. When the locking section 110 writes a plurality of user IDs into the single encrypted folder 128, the encrypted folder 128 can be shared by a plurality of users.

The locking section 110 may further write the address of the key distribution server 200 into the encrypted folder 128. In this case, the viewing request section 160 can establish a connection with the key distribution server 200 at the address written in the encrypted file 128. With this configuration, even when the encrypted folder 128 is stored on a location other than the PC 100, the PC 100 can establish a connection with the key distribution server 200 to acquire an unlocking key.

The user database 220 may store thereon the e-mail address of the mobile telephone 300 owned by the user in association with the user ID. In this case, when writing the user ID of the unlocking right owner into the encrypted folder, the PC 100 transmits the user ID of the unlocking right owner to the key distribution server 200. The key distribution server 200 may read the e-mail address of the mobile telephone 300 owned by the user from the user database 220 by using, as a key, the user ID received from the PC 100, and send an e-mail informing that the user ID received from the PC 100 is set as the user ID of the unlocking right owner of the encrypted folder, to the e-mail address of the mobile telephone 300 which is read from the user database 220. With this configuration, the encryption key distribution system 500 can inform the user that the mobile telephone 300 is required to unlock the encrypted folder 128.

The key distribution server 200 may send, to the PC 100, a message informing that the user ID received from the PC 100 is permitted to be set as the user ID of the unlocking right owner for the encrypted folder, under the condition that the key distribution server 200 receives a replay e-mail from the e-mail address within a predetermined time limit from the timing of sending the e-mail. If such is the case, the PC 100 sets the user ID transmitted to the key distribution server 200 to be the user ID of the unlocking right owner for the encrypted folder, under the condition that the PC 100 receives the message informing the permission from the key distribution server 200. With this configuration, the encryption key distribution system 500 can prevent a case where, even when the mobile telephone 300 is not used or does not exist, the mobile telephone 300 is set as the key used for the authentication. Consequently, the encryption key distribution system 500 can avoid a case where the encrypted folder becomes unable to be unlocked.

The key distribution server 200 may transmit a link to a website which enables the mobile telephone 300 to download an application program for authentication. The application program for authentication causes the mobile telephone 300 to realize the functions of accessing the key distribution server 200 and transmitting authentication data to the key distribution server 200. The key distribution server 200 adds the link to the above-mentioned download website to the e-mail to be sent to the e-mail address of the mobile telephone 300, and sends the resulting e-mail. With this configuration, the encryption key distribution system 500 can supply the above-mentioned application program to the mobile telephone 300 when informing the user that the mobile telephone 300 is required to unlock the encrypted folder 128.

When writing the user ID of the unlocking right owner into the encrypted folder 128, the locking section 110 may transmit the user ID of the unlocking right owner to the key distribution server 200. In response to this, the key distribution server 200 reads the e-mail address of the user from the user database 220 by using, as a key, the user ID received from the PC 100. Here, the key distribution server 200 may create a website exclusively for enabling the user to decide whether to be registered as the unlocking right owner of the encrypted folder, and send an e-mail attached with the link to the created website to the e-mail address read from the user database 220.

The key distribution server 200 sends a message, to the PC 100, informing that the user ID received from the PC 100 is permitted to be set as the user ID of the unlocking right owner for the encrypted folder, under the condition that the key distribution server 200 detects, on the created website, input made by the user indicating that the user decides to be registered as the unlocking right owner within a predetermined time limit from the timing of sending the e-mail. The PC 100 sets the user ID transmitted to the key distribution server 200 as the user ID of the unlocking right owner for the encrypted folder, under the condition that the PC 100 receives the message informing the permission from the key distribution server 200. With this configuration, the encryption key distribution system 500 can prevent a case where, even when the mobile telephone 300 is not used or does not exist, the mobile telephone 300 is set as the key for the authentication. Consequently, the encryption key distribution system 500 can avoid a case where the encrypted folder becomes unable to be unlocked.

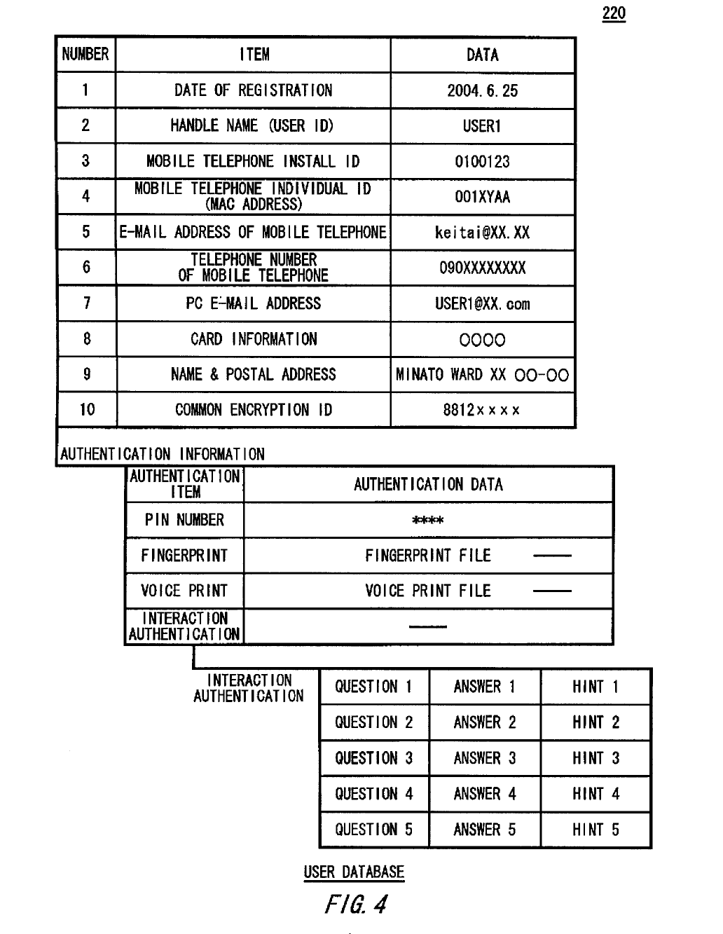

FIG. 4 illustrates an example of the data stored on the user database 220. The user database 220 stores thereon, in association with a user ID used as, for example, a handle name, a date of registration, a mobile telephone install ID, a mobile telephone individual ID, an e-mail address of the mobile telephone, the telephone number of the mobile telephone, a PC e-mail address, card information, a postal address and a name, and a common encryption ID. The mobile telephone install ID is a logically unique ID which is supplied to the mobile telephone 300 every time the application program which causes the mobile telephone 300 to realize the function of accessing the authentication section 210 and performing the authentication operation (hereinafter referred to as “the authentication program for the mobile telephone”) is distributed to the mobile telephone 300. The mobile telephone install ID is, for example, issued with sequential numbers in the same format, every time the authentication program for the mobile telephone is distributed to the mobile telephone 300. The mobile telephone individual ID is one example of the authentication data unique to the mobile communication terminal, for example, a MAC address. The user database 220 further stores thereon additional authentication items to be used to authenticate the user. For example, the user database 220 stores thereon a PIN number, a voice print, fingerprints, and data for interaction authentication. In the field of the data for interaction authentication, the user database 220 stores a plurality of combinations of a question, an answer, and a hint which are set by the user.

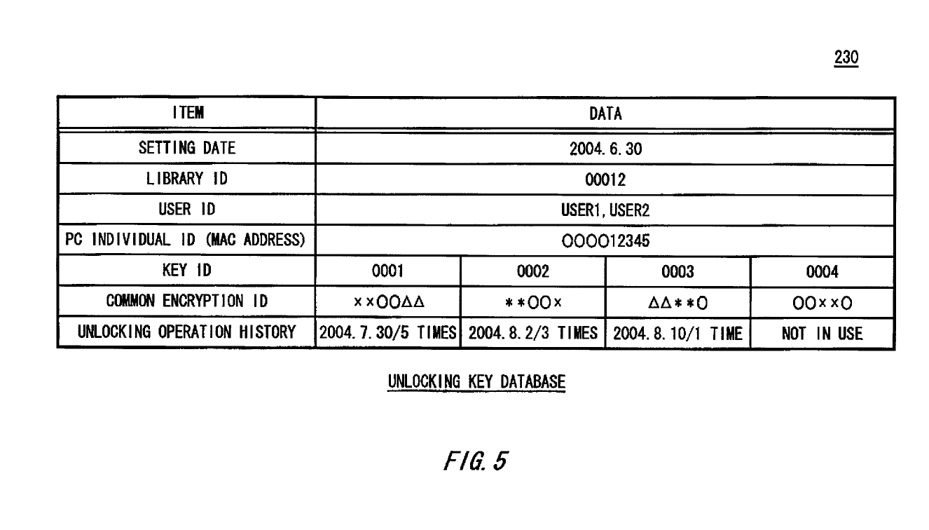

FIG. 5 illustrates an example of the data stored on the unlocking key database 230. The unlocking key database 230 stores thereon the individual ID, for example, the MAC address of the PC 100 in association with encrypted folders which the PC 100 is permitted to view. The unlocking key database 230 stores thereon, in association with the individual ID, a setting date on which a key library is set on the unlocking key database 230, that is to say, the date on which the application realizing the system is installed in the PC 100. The unlocking key database 230 further stores thereon, in association with the individual ID, a library ID for identifying the corresponding key library, and one or more user IDs identifying one or more users who are permitted to use the key library. The library ID is, for example, a serial number which is uniquely assigned to each key library. The unlocking key database 230 may store thereon a management ID uniquely corresponding to the individual ID. The management ID is, for example, a serial number which is sequentially numbered and assigned when the above-mentioned application is installed.

The unlocking key database 230 further stores thereon, in association with each key ID identifying an unlocking key, a common encryption ID of the corresponding unlocking key and the history of unlocking operations based on the corresponding unlocking key. Here, the key distribution server 200 may manage the setting date, the individual ID of the PC 100 and the management ID on a different database. If such is the case, the unlocking key database 230 stores thereon one of the management ID and individual ID, so that the unlocking key database 230 and PC 100 are associated with each other. Since the unlocking key database 230 stores thereon the individual ID of the PC 100, it is made possible to limitedly identify encrypted folders which the PC 100 is permitted to view. Here, the common encryption ID is shown as one example of the unlocking key relating to the present invention. Referring to the history of unlocking operations, the total number of times at which the corresponding unlocking key is transmitted to the PC 100 is recorded as the number of unlocking operations based on the unlocking key. The history of unlocking operations includes the most recent date and time on which the corresponding unlocking key is transmitted to the PC 100. Every time the authentication section 210 transmits the unlocking key to the PC 100, the authentication section 210 updates the transmission date and time of the unlocking key, and updates the number of unlocking operations by incrementing the number by one. Every time the authentication section 210 updates the number of unlocking operations, the authentication section 210 transmits the number of unlocking operations to the PC 100 in association with the key ID.

When receiving a request to view an encrypted folder, for example, when the encrypted folder is double-clicked, the viewing request section 160 may request a user to input a user ID. The viewing request section 160 may then transmit the input user ID to the key distribution server 200, together with the viewing request of the encrypted folder. When receiving the viewing request of the encrypted folder and the user ID input into the PC 100 from the PC 100, the authentication section 210 may acquire the individual ID, for example, the MAC address identifying the PC 100 from the PC 100 and store, in association with the key ID written in the encrypted folder, onto the unlocking key database 230, the date and time of receiving the viewing request from the PC 100, the individual ID of the PC 100, the user ID input into the PC 100, and the result of authenticating the user who accesses the key distribution server 200 with the use of the mobile telephone 300. With this configuration, the encryption key distribution system 500 can keep a record of the user ID of a user who issues a viewing request of an encrypted folder in an attempt to view the encrypted folder but fails to be authenticated, in association with each key ID.

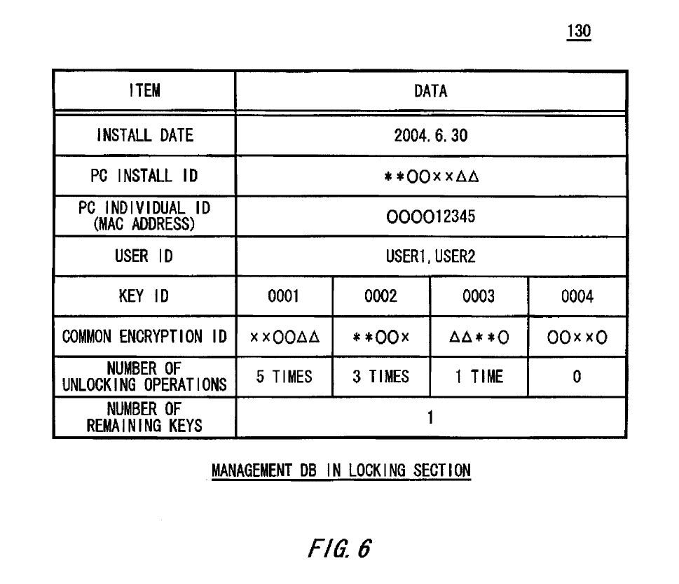

FIG. 6 illustrates one example of the data stored on the management database 130 included in the locking section 110. The management database 130 stores thereon a PC install ID which is assigned by the server, the individual ID, for example, the MAC address of the PC 100, one or more user IDs of one or more users who use the locks, and a install date on which an application for the PC is installed. The PC install ID is a logically unique ID which is assigned to the PC 100 by the key distribution server 200 every time an application program causing the PC 100 to realize the function of the locking section 110 (hereinafter referred to as “the locking program”) is distributed to the PC 100. The PC install ID is, for example, issued with sequential numbers in the same format every time the locking program is distributed to the PC 100. Here, the main key of the management database 130 may be either of the PC individual ID and PC install ID.

The management database 130 further stores thereon, in association with the key ID identifying each of the locks stored on the lock database 135, a common encryption ID for the corresponding lock. Here, the common encryption ID is a common code shared by the common encryption ID stored on the unlocking key database 230. The common encryption ID is shown as one example of the lock relating to the present invention. The management database 130 further stores thereon, as the number of remaining keys, the number of locks which are stored on the lock database 135 but not currently used. The number of remaining keys is obtained by subtracting the number of currently used locks from the maximum number of available locks. The management database 130 further stores thereon the number of unlocking operations based on an unlocking key which is received from the key distribution server 200, in association with the corresponding key ID. When locking a folder with the use of a lock, the locking section 110 reads the number of unlocking operations by using, as a key, the key ID identifying the lock used, modifies the lock by using the read number of unlocking operations in accordance with a predetermined algorithm, and locks the folder by using the modified lock.

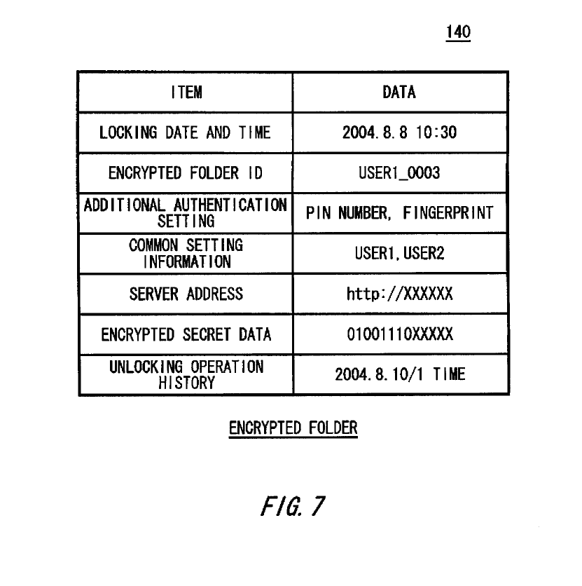

FIG. 7 illustrates exemplary data items of an encrypted folder stored on the file database 140. The file database 140 stores, in association with the encrypted folder ID identifying the encrypted folder, the date and time on which the encrypted folder is generated, the additional authentication setting, the common setting information, the address of the key distribution server 200, the encrypted secret data, and the history of unlocking operations performed on the encrypted folder. The encrypted folder ID includes, for example, the user ID of a user who has generated the encrypted folder and the key ID identifying a lock used to generate the encrypted folder. The additional authentication setting includes one or more additional authentication items set via the additional authentication setting section 20 of the lock window 122. The file database 140 may store, in association with the encrypted folder ID, one of the PC individual ID and PC install ID which identify the PC 100 as being permitted to view the corresponding encrypted folder.

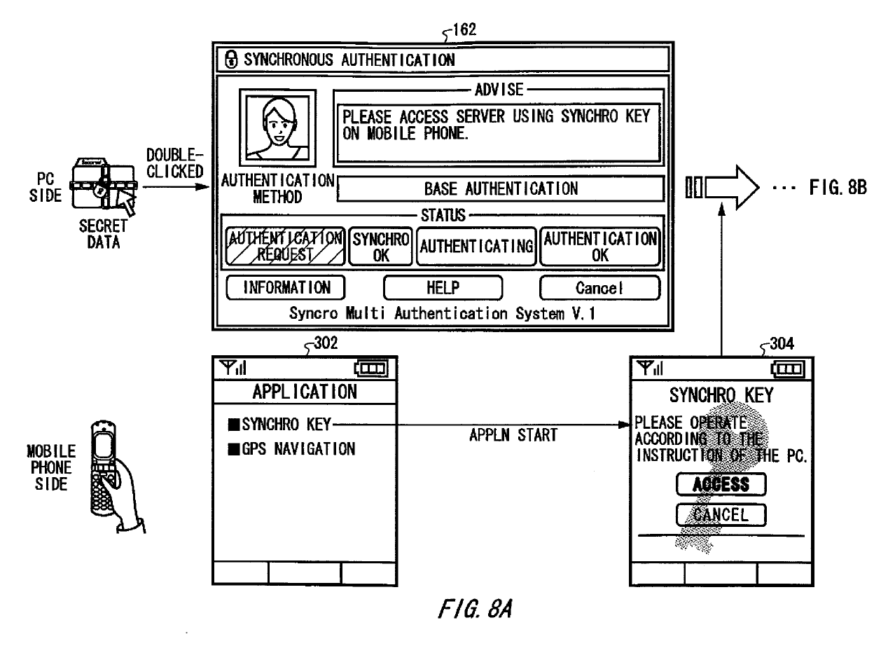

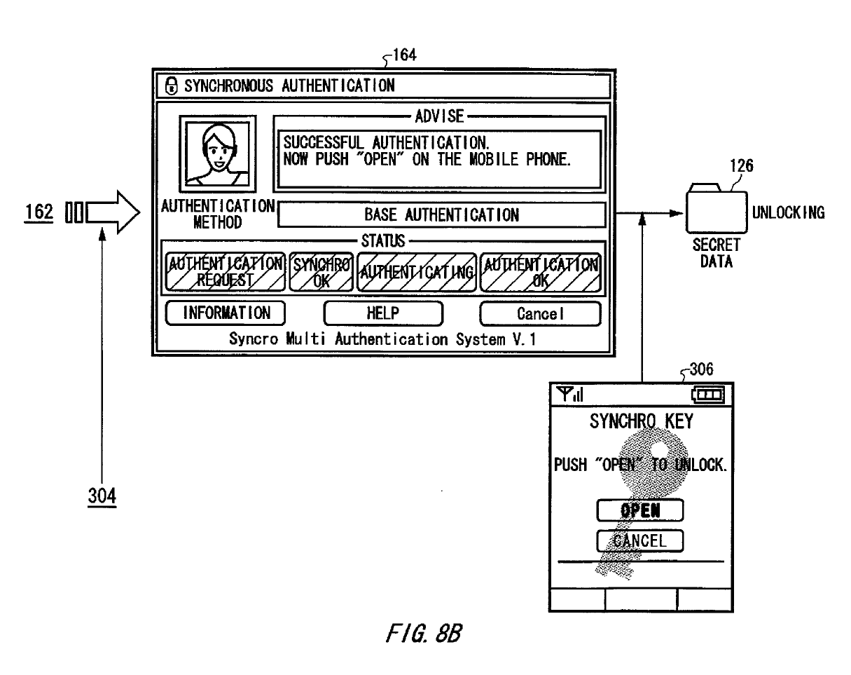

FIGS. 8A and 8B illustrate, as an example, screen transition for the PC 100 and mobile telephone 300 which is seen when the authentication section 210 authenticates the mobile telephone 300. On the PC 100, an encrypted folder is double-clicked to issue a request to view the encrypted folder. On detecting this, the viewing request section 160 displays an authentication screen 162 which requests a user to execute an authentication program on the mobile telephone of the user in order to authenticate the user. In response to this, the user starts the authentication program (from SYNCHRO KEY in FIGS. 8A and 8B) via an application starting screen 302. Subsequently, the mobile telephone 300 displays a screen 304 requesting the user to decide whether to establish a connection with the key distribution server 200 in accordance with the authentication program. When receiving a decision to establish a connection with the key distribution server 200, the mobile telephone 300 establishes a connection with the key distribution server 200 and transmits the MAC address of the mobile telephone 300 to the key distribution server 200.

The key distribution server 200 authenticates the MAC address received from the mobile telephone 300. When successfully authenticating the MAC address of the mobile telephone 300, the key distribution server 200 notifies the PC 100 and mobile telephone 300 that the authentication is successful. When notified that the key distribution server 200 successfully authenticates the mobile telephone 300, the PC 100 displays a window 164 which requests the user to input decision, via the screen of the mobile telephone 300, to unlock the encrypted folder. On the other hand, the mobile telephone 300 displays a window 306 to receive the input of decision (via OPEN button in FIG. 8B) to unlock the encrypted folder, when notified that the key distribution server 200 successfully authenticates the mobile telephone 300. When the OPEN button is selected to unlock the encrypted folder via the window 306, the encrypted folder is unlocked, to generate a secret folder 126.

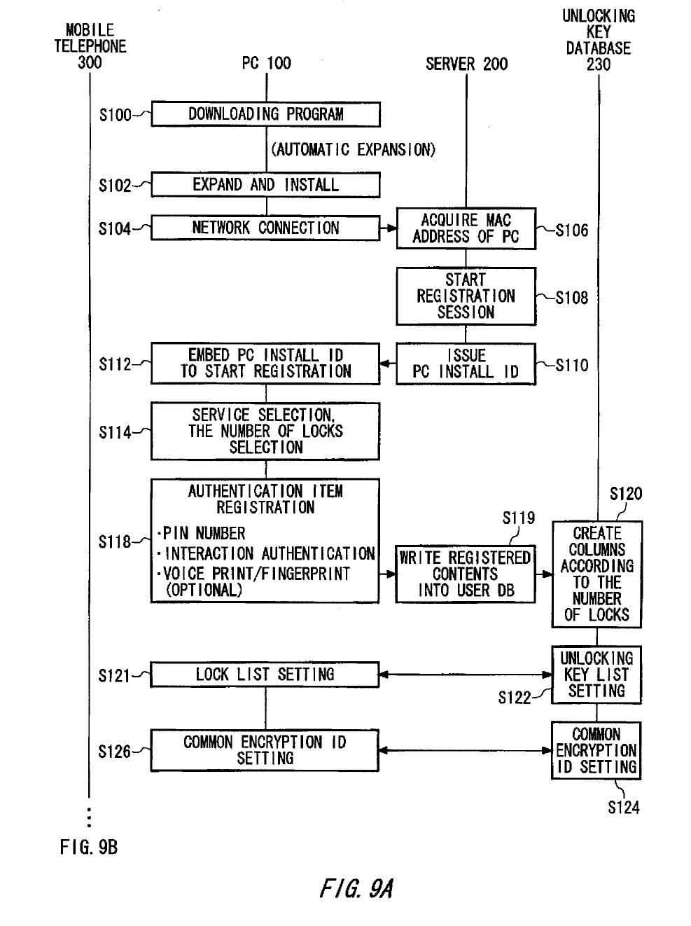

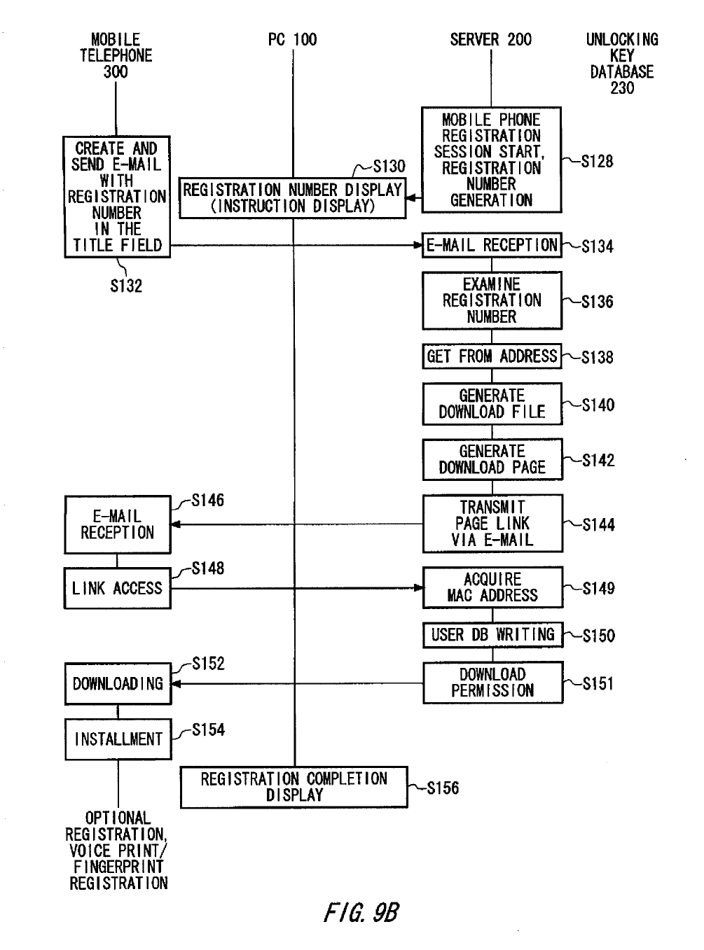

FIGS. 9A and 9B illustrate an exemplary sequence of processes performed when the encryption key distribution system 500 records a new combination of a lock and an unlocking key. To begin with, the PC 100 downloads a PC application program for causing the PC 100 to realize the functions of the above-described locking section 110, unlocking section 150 and viewing request section 160 (hereinafter referred to as “the locking/viewing program”) from, for example, the key distribution server 200 (step S100). The PC 100 automatically expands and thus installs the locking/viewing program therein (step S102). The PC 100 accesses the key distribution server 200 in accordance with the locking/viewing program (step S104).

When receiving the access made by the PC 100, the key distribution server 200 acquires the MAC address of the PC 100 and generates a new table by using the acquired MAC address as the main key, on the unlocking key database 230 (step S106). The key distribution server 200 then starts a registration session to register the PC 100 (step S108), issues a PC install ID which identifies the PC 100, and transmits the PC install ID to the PC 100 (step S110). The PC 100 generates a new table by using, as the main key, the PC install ID received from the key distribution server 200, on the management database 130 (step S112). Subsequently, the PC 100 receives a selection of the number of locks to be used, in accordance with the locking/viewing program (step S114). Following this, the PC 100 receives registration of one or more available additional authentication items and input of a user ID, and transmits the input data to the key distribution server 200 (step S118).

The key distribution server 200 generates a new table by using, as the main key, the user ID received from the PC 100, on the user database 220, and writes the data received from the PC 100 into the table (step S119). The key distribution server 200 further generates one or more columns the number of which is determined in accordance with the number of locks which is selected by the user, in a corresponding table on the unlocking key database 230. After this, the PC 100 sets a lock list displaying locks, based on the number of locks which is selected by the user (step S121). Similarly, the key distribution server 200 sets an unlocking key list displaying unlocking keys, based on the number of locks which is selected by the user (step S122).

The key distribution server 200 generates key IDs the number of which is determined in accordance with the number of locks, and also generates a common encryption ID for each of the key IDs. The key distribution server 200 generates the common encryption ID based on, for example, the PC install ID and key ID. The key distribution server 200 stores the generated common encryption ID in association with the corresponding key ID, on the unlocking key database 230 (step S124). In this way, a new key library is generated on the unlocking key database 230. The key distribution server 200 transmits, to the PC 100, the common encryption ID in association with the key ID. The PC 100 stores the received common encryption ID in association with the key ID on the management database 130 (step S126). As a result of the above steps, the registration of the PC 100 is completed.

After this, the key distribution server 200 starts a session to register the mobile telephone 300 of the user who uses the encryption key distribution system 500 (step S128). To start with, the key distribution server 200 receives, via the PC 100, the user ID, authentication information used for additional authentication of the user, the e-mail address of the user, and the like. The key distribution server 200 generates a registration number unique to the user ID and transmits the registration number to the PC 100 (step S128). The PC 100 displays the registration number received from the key distribution server 200. The user creates an e-mail having the registration number displayed on the PC 100 in the title field thereof, and sends the e-mail to the e-mail address of the key distribution server 200 which is displayed on the PC 100 (step S132). When receiving the e-mail from the mobile telephone 300 (step S134), the key distribution server 200 examines the registration number in the title field of the e-mail (step S136), and acquires the From address of the e-mail (step S138). Furthermore, the key distribution server 200 generates a download file for a mobile telephone authentication program (step S140).

Subsequently, the key distribution server 200 generates a download page for acquiring the mobile telephone authentication program (step S142), and sends an e-mail having therein a link to the generated download page, to the e-mail address acquired in the step S138 (step S144). The mobile telephone 300 receives the e-mail from the key distribution server 200 (step S146) and accesses the link included in the received e-mail, so as to establish a connection with the key distribution server 200 (step S148). The key distribution server 200 acquires the MAC address of the mobile telephone 300 from the mobile telephone 300 (step S149). The key distribution server 200 then writes, into the user database 220, the acquired MAC address in association with the user ID identified by the registration number (step S150), and permits the mobile telephone 300 to download the mobile telephone authentication program (step S151).

The mobile telephone 300 downloads the mobile telephone authentication program from the key distribution server 200 (step S152) and installs therein the downloaded mobile telephone authentication program (step S154). In this case, the key distribution server 200 issues a mobile telephone install ID unique to the mobile telephone 300, and transmits the mobile telephone install ID to the mobile telephone 300. The mobile telephone 300 stores thereon the received mobile telephone install ID in association with the mobile telephone authentication program. The key distribution server 200 notifies the PC 100 that the download of the application has been completed, and the PC 100 displays a message indicating that the registration of the mobile telephone 300 has been completed (step S156). This is the end of the procedure. After this, the mobile telephone 300 may optionally register additional authentication items such as a PIN number, a voice print, fingerprints, and interaction authentication.

Note that FIGS. 8A and 8B illustrate an exemplary procedure in which the registration operations of the PC 100 and mobile telephone 300 are successively performed. However, each of the registration operations may be independently performed. For example, the registration operation of the PC 100 involving the steps S100 to S126 and the registration operation of the mobile telephone 300 involving the steps S128 to S156 may be separately performed at different timings selected by the user. If this is the case, a plurality of mobile telephones 300 owned by a plurality of users can be easily registered in association with the single PC 100.

Once the key distribution server 200 registers the PC 100 and mobile telephone 300, a user can be registered in association with a lock stored on the PC 100. The user registration is performed in the following manner. In response to a request of user account registration, the PC 100 waits for receiving input of the mobile telephone install ID of the mobile telephone 300. Here, the mobile telephone install ID is displayed on the screen of the mobile telephone 300 when the mobile telephone 300 starts the authentication program. The user inputs, into the PC 100, the mobile telephone install ID displayed on the screen of the mobile telephone 300.

The key distribution server 200 reads a user ID from the user database 220 by using, as a key, the input mobile telephone install ID. Also, the key distribution server 200 acquires the individual ID (MAC address or the like) of the PC 100 from the PC 100, and identifies a key library corresponding to the PC 100 in the unlocking key database 230 by using, as a key, the acquired individual ID. Subsequently, the key distribution server 200 registers the user ID in association with the individual ID of the PC 100. In this manner, the user registration can be completed in association with the locks stored on the PC 100. When the user registration is completed in association with the locks, the key distribution server 200 requests the PC 100 to open a lock window uniquely assigned to the user. In response to the request, the PC 100 opens the lock window uniquely assigned to the user, as shown in FIG. 2.

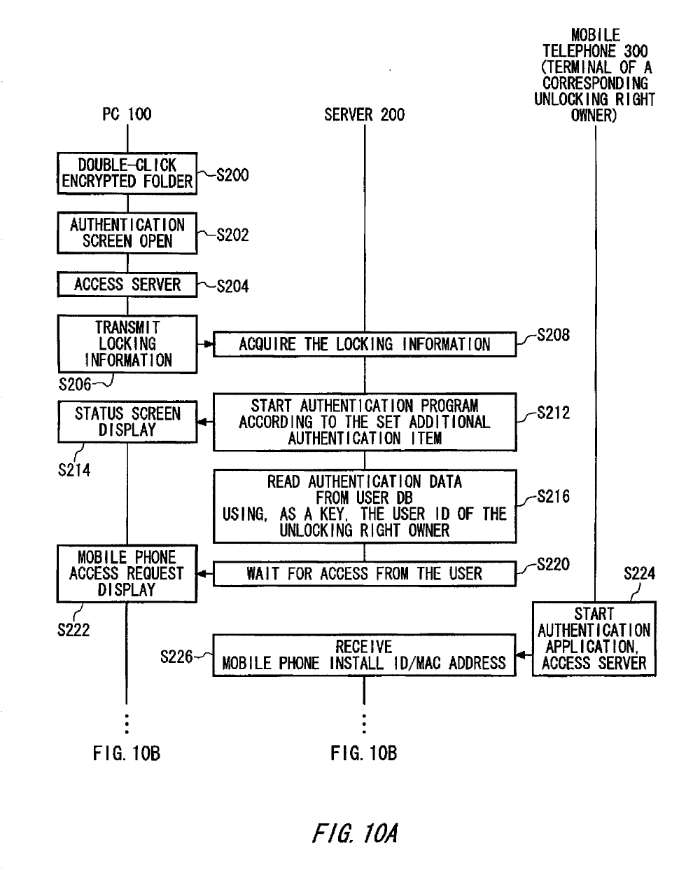

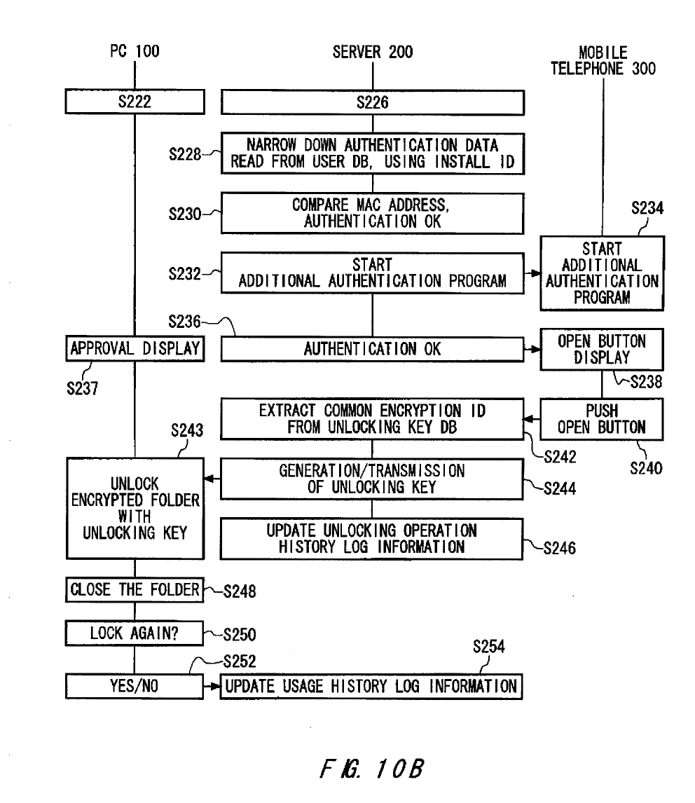

FIGS. 10A and 10B illustrate an exemplary sequence of processes performed when the encryption key distribution system 500 unlocks an encrypted folder. To start with, when an encrypted folder is double-clicked on the PC 100 (step S200), the viewing request section 160 opens the authentication screen 162, which is shown in FIG. 8A as an example (step S202), and accesses the key distribution server 200 based on the address of the key distribution server 200 which is written in the encrypted folder (step S204). Subsequently, the viewing request section 160 transmits, as a viewing request of the encrypted folder, locking information which includes an encrypted folder ID, one or more user IDs of one or more unlocking right owners which are written in the encrypted folder as the common setting information, and additional authentication setting, to the key distribution server 200 (step S206). When the encrypted folder includes therein the individual ID of a viewing terminal which is permitted to view the encrypted folder, the viewing request section 160 reads the individual ID from the encrypted folder and further transmits the read individual ID to the key distribution server 200.

The authentication section 210 acquires, from the PC 100, the locking information and the address of the PC 100 (step S208). The locking information includes the encrypted folder ID, additional authentication setting and common setting information. The key distribution server 200 may read e-mail addresses from the user database 220 by using, as a key, the user IDs of the unlocking right owners which are included in the encrypted folder, and send e-mails, to the read e-mail addresses, informing that the key distribution server 200 has received the viewing request of the encrypted folder. When receiving from the PC 100 the individual ID of the viewing terminal which may be written in the encrypted folder, the authentication section 210 performs the subsequent processes under the condition that the received individual ID of the viewing terminal matches the individual ID of the PC 100.

Following this, the key distribution server 200 starts an authentication program for performing authentication based on the additional authentication setting (step S212), and the PC 100 displays a status screen informing that authentication corresponding to the additional authentication information is required (step S214). The key distribution server 200 reads the mobile telephone individual IDs (e.g. MAC addresses) and the mobile telephone install IDs of a plurality of mobile telephones 300 from the user database 220 by using, as a key, the user IDs of the unlocking right owners which are written in the encrypted folder (step S216), and waits for an access from the mobile telephones 300 owned by the corresponding users (step S220). The key distribution server 200 notifies the PC 100 of the user IDs of the unlocking right owners. The PC 100 displays, in the authentication screen 162, the user IDs of the unlocking right owners which are received from the key distribution server 200 and a message informing that the mobile telephones owned by the users corresponding to the displayed user IDs need to access the key distribution server 200 and perform user authentication (step S222). Here, the mobile telephone 300 starts a mobile telephone authentication program in accordance with the user's operation so as to access the key distribution server 200, and transmits the mobile telephone individual ID (e.g. MAC address) and the mobile telephone install ID of the mobile telephone 300, to the key distribution server 200 (step S224).

When receiving the access from the mobile telephone 300, the authentication section 210 receives the MAC address and the mobile telephone install ID from the mobile telephone 300 (step S226). The authentication section 210 then narrows down the mobile telephone install IDs and MAC addresses which are read from the user database 220 in the step S216, based on the mobile telephone install ID received from the mobile telephone 300 (step S228). The authentication section 210 subsequently compares the MAC address received from the mobile telephone 300 with the MAC address read from the user database 220. Under the condition that the compared MAC addresses match each other, the authentication section 210 successfully authenticates the mobile telephone 300 (step S230).

After this, the key distribution server 200 and mobile telephone 300 start an additional authentication program to execute additional authentication, based on the additional authentication setting acquired in the step S208 (steps S232 and S234). When successfully authenticating the user in accordance with the additional authentication program (step S236), the key distribution server 200 notifies the mobile telephone 300 of the successful authentication, and the mobile telephone 300 receives the notification of the successful authentication and displays a decision button (OPEN button) used to unlock the encrypted folder (step S238). The processes of the steps S232 to S236 are performed to authenticate the unlocking right owner based on one or any combination of interaction authentication, voice print authentication, fingerprint authentication, and PIN number authentication, in addition to the authentication based on the individual ID of the mobile telephone 300. Consequently, the encryption key distribution system 500 can reliably authenticate the unlocking right owner.

When the decision button is selected, the mobile telephone 300 informs the key distribution server 200 that the decision button is selected (step S240). When receiving the notification, the key distribution server 200 reads a common encryption ID and the number of unlocking operations from the unlocking key database 230 by using, as a key, the key ID identified by the encrypted folder ID (step S242). The key distribution server 200 then generates a new unlocking key based on the number of unlocking operations and the common encryption ID, in accordance with the same algorithm as the algorithm used by the PC 100 to generate a new lock based on the number of unlocking operations and common encryption ID, and transmits the generated new unlocking key to the address of the PC 100 (step S244). The key distribution server 200 subsequently increments by one the number of unlocking operations which is stored in association with the key ID on the unlocking key database 230, and updates the date and time of the most recent unlocking operation, with the date and time of transmitting the new unlocking key (step S246).

The unlocking section 150 of the PC 100 unlocks the encrypted folder viewing of which is requested, with the use of the unlocking key received from the key distribution server 200, and displays the unlocked folder in a normal format (step S243). Referring to the step S243, it should be noted that the unlocking section 150 deletes the unlocking key received from the key distribution server 200 once the unlocking operation of the encrypted folder is completed. With this configuration, the encryption key distribution system 500 can prevent the unlocking key from being duplicated. Afterwards, when the folder is closed (step S248), the unlocking section 150 stores the unlocked folder onto the file database 140. In this case, the locking section 110 displays a screen for enabling the user to select whether to lock again the folder with the same lock (step S250), and transmits the selection made by the user to the key distribution server 200 (step S252). When receiving, from the PC 100, the selection indicating that the folder is to be locked again with the same lock, the key distribution server 200 reads the usage history corresponding to the key ID identifying the lock from the management database 130 and updates the read usage history (step S254). This is the end of the procedure.

In the step S220, the key distribution server 200 may read e-mail addresses of the mobile telephones of the unlocking right owners from the user database 220 by using, as a key, the user IDs of the unlocking right owners which are included in the viewing request acquired in the step S208, and send e-mails, to the read e-mail addresses, requesting the unlocking right owners to execute the mobile telephone authentication program of the mobile telephone 300 and authenticate themselves as the unlocking right owners who are permitted to unlock the encrypted file. In this case, the key distribution server 200 may add, to the e-mails, the link to the download website for the mobile telephone authentication program. With this configuration, during the procedure to unlock an encrypted folder, the encryption key distribution system 500 can easily install the mobile telephone authentication program in the mobile telephone 300, when the mobile telephone authentication program is not installed in the mobile telephone 300.

When the authentication of the mobile telephone 300 is unsuccessful in the step S230, the key distribution server 200 may read e-mail addresses of the unlocking right owners from the user database 220 by using, as a key, the user IDs of the unlocking right owners which are written in the encrypted folder viewing of which is requested, and send a message, to the read e-mail addresses, informing that the viewing request is issued but the authentication is unsuccessful. With this configuration, the encryption key distribution system 500 can notify the mobile telephones 300 owned by the legal unlocking right owners that the viewing request is issued but the authentication is unsuccessful.

In the step S202, the viewing request section 160 may request the user to input a user ID. When the user inputs a user ID, the viewing request section 160 may transmit a different user ID written in the encrypted folder to the key distribution server 200, separately from the user ID input into the PC 100, under the condition that the input user ID is one of the user IDs written in the encrypted folder. In this case, under the condition that the key distribution server 200 successfully authenticates the user identified by the user ID input into the PC 100 as one of the unlocking right owners of the encrypted folder, the key distribution server 200 reads an e-mail address of a mobile telephone 300 from the user database 220 by using, as a key, the different user ID written in the encrypted folder and sends an e-mail, to the e-mail address read from the user database 220, informing that the user identified by the user ID input into the PC 100 is about to unlock the encrypted folder. With this configuration, the encryption key distribution system 500 can notify the unlocking right owner different from the user who unlocks the encrypted folder via the PC 100, of the user who is to view the encrypted file.

According to the present embodiment, the unlocking key database 230 stores thereon the history of unlocking operations in association with each key ID. With this configuration, the encryption key distribution system 500 can reliably manage the usage histories of the locks and unlocking keys. Consequently, when the user of the PC 100 is charged for using the encryption key distribution service realized by the encryption key distribution system 500, the usage histories of the encryption keys can be quantitatively managed, so that the fees to be charged can be easily obtained in accordance with the usage histories.

As clearly indicated by the above description, the encryption key distribution system 500 relating to the present embodiment can be easily operated, highly freely share the data therein, and achieve high reliability for authentication of unlocking right owners who are assigned to each encrypted folder.

While one aspect of the present invention has been described through the embodiments, the technical scope of the invention is not limited to the above described embodiments. It is apparent to persons skilled in the art that various alternations and improvements can be added to the above-described embodiments. It is also apparent from the scope of the claims that the embodiments added with such alternations or improvements can be included in the technical scope of the invention.

What is claimed is:

1. An encryption key distribution system comprising:
a locking terminal that stores thereon an encryption key used to encrypt a folder and generates an encrypted folder by encrypting the folder by using the encryption key;
a key distribution server that stores thereon, in association with the encryption key, a decryption key used to decrypt the encrypted folder which is encrypted by the locking terminal using the encryption key;
a viewing terminal that (i) stores thereon the encrypted folder which is encrypted by the locking terminal using the encryption key, (ii) when receiving a request to view the encrypted folder, transmits the request to view the encrypted folder to the key distribution server, and (iii) when receiving the decryption key corresponding to the encrypted folder from the key distribution server, unlocks the encrypted folder by using the decryption key; and
a mobile communication terminal that is registered in the key distribution server as an authentication key used to authenticate a user, wherein
when receiving the request to view the encrypted folder from the viewing terminal, the key distribution server transmits the decryption key to the viewing terminal, under a condition that the key distribution server receives an access from the mobile communication terminal owned by the user who is set as an unlocking right owner of the encrypted folder.

2. The encryption key distribution system as set forth in claim 1, wherein
the key distribution server comprises:
a decryption key database that stores thereon the decryption key in association with a key ID that identifies a combination of the encryption key and the decryption key;
a user database that stores thereon authentication data unique to the mobile communication terminal owned by the user, in association with a user ID of the user; and
an authentication section that, when the key distribution server receives the request to view the encrypted folder from the viewing terminal, (i) receives a viewing request including therein (a) the user ID of the unlocking right owner who is entitled to decrypt the encrypted folder and (b) the key ID that identifies the encryption key used to generate the encrypted folder, (ii) acquires an address of the viewing terminal, (iii) reads the authentication data from the user database by using, as a key, the user ID of the unlocking right owner included in the viewing request, and (iv) waits for the access from the mobile communication terminal, and
when receiving the access from the mobile communication terminal, the authentication section of the key distribution server (I) receives the authentication data from the mobile communication terminal, (II) compares the authentication data received from the mobile communication terminal with the authentication data read from the user database, (III) successfully authenticates the mobile communication terminal under a condition that the compared pieces of authentication data match each other, (IV) reads the decryption key from the decryption key database by using, as a key, the key ID included in the viewing request, under a condition that the authentication of the mobile communication terminal is successful, and (V) transmits the read decryption key to the acquired address of the viewing terminal.

3. The encryption key distribution system as set forth in claim 1, wherein
the locking terminal includes a locking section that generates the encrypted folder by encrypting the folder by using the encryption key, and writes, into the encrypted folder, (i) the user ID of the unlocking right owner who is entitled to decrypt the encrypted folder and (ii) the key ID that identifies the encryption key used to generate the encrypted folder.

4. The encryption key distribution system as set forth in claim 1, wherein
the viewing terminal includes:
a viewing request section that, when the viewing terminal receives the request to view the encrypted folder, establishes a connection with the key distribution server, and transmits, as the viewing request of the encrypted folder, the user ID of the unlocking right owner and the key ID which are written in the encrypted folder, to the key distribution server; and
an unlocking section that decrypts the encrypted folder the viewing of which is requested, by using the decryption key received from the key distribution server.

5. The encryption key distribution system as set forth in claim 1, wherein
when the viewing terminal transmits the request to view the encrypted folder to the key distribution server, the mobile communication terminal accesses the key distribution server to transmit the authentication data unique to the mobile communication terminal.

6. The encryption key distribution system as set forth in claim 5, wherein
the authentication section of the key distribution server (i) stores, onto the decryption key database, the number of times at which the authentication section transmits the decryption key to the viewing terminal, as the number of unlocking operations based on the decryption key, in association with the key ID, (ii) updates the number of unlocking operations based on the decryption key by incrementing the number, every time the authentication section transmits the decryption key to the viewing terminal, and (iii) transmits the number of unlocking operations to the locking terminal in association with the key ID, every time the authentication section updates the number of unlocking operations,
the locking terminal further includes a management database that stores thereon, in association with the key ID, the number of unlocking operations based on the decryption key which is received from the key distribution server,
when encrypting the folder by using the encryption key, the locking section (i) reads the number of unlocking operations from the management database by using, as a key, the key ID that identifies the encryption key to be used, (ii) modifies the encryption key by using the number of unlocking operations which is read from the management database in accordance with a predetermined algorithm, and (iii) encrypts the folder by using the modified encryption key,
when reading the decryption key and transmitting the read decryption key to the address of the viewing terminal, the authentication section (I) reads the number of unlocking operations from the decryption key database by using, as a key, the key ID that identifies the decryption key, (II) modifies the decryption key by using the read number of unlocking operations in accordance with the same predetermined algorithm used by the locking terminal to modify the encryption key, and (III) transmits the modified decryption key to the address of the viewing terminal, and
the unlocking section decrypts the encrypted folder which is generated by encrypting the folder by using the modified encryption key, by using the modified decryption key.

7. The encryption key distribution system as set forth in claim 5, wherein
the locking terminal writes, into the single encrypted folder, a plurality of user IDs which identify a plurality of unlocking right owners.

8. The encryption key distribution system as set forth in claim 7, wherein
the key distribution server stores, on the user database, an e-mail address of the mobile communication terminal owned by the user, in association with the user ID,
when receiving the request to view the encrypted folder, the viewing terminal (i) requests a user to input a user ID, and (ii) when the user inputs the user ID, further transmits, to the key distribution server, a different user ID than the user ID input into the viewing terminal, which is selected from the plurality of user IDs which are written in the encrypted folder to identify the plurality of unlocking right owners for the encrypted folder, under a condition that the input user ID is included in the plurality of user IDs written in the encrypted folder, and
when successfully authenticating the user identified by the user ID input into the viewing terminal as the unlocking right owner of the encrypted folder, the key distribution server reads an e-mail address of a mobile communication terminal from the user database by using, as a key, the different user ID than the user ID input into the viewing terminal which is selected from the plurality of user IDs written in the encrypted folder, and sends an e-mail, to the read e-mail address, informing that the decryption key to decrypt the encrypted folder is distributed.

9. The encryption key distribution system as set forth in claim 5, wherein
the key distribution server stores, on the user database, an e-mail address of the mobile communication terminal owned by the user, in association with the user ID,
when receiving the request to view the encrypted folder, the viewing terminal (i) requests a user to input a user ID, and (ii) when the user inputs the user ID, transmits the input user ID to the key distribution server, under a condition that the input user ID is included in the user ID which is written in the encrypted folder to identify the unlocking right owner for the encrypted folder, and
the key distribution server reads the e-mail address of the mobile communication terminal owned by the user from the user database by using, as a key, the user ID input into the viewing terminal, and sends an e-mail, to the read e-mail address, including a message informing that a necessary procedure is required to be performed to authenticate the user of the mobile communication terminal as the unlocking right owner of the encrypted folder.

10. The encryption key distribution system as set forth in claim 5, wherein
when receiving the request to view the encrypted folder, the viewing terminal requests a user to input a user ID, and transmits the input user ID and the viewing request of the encrypted folder, to the key distribution server, and
when receiving, from the viewing terminal, the viewing request of the encrypted folder and the user ID input into the viewing terminal, the key distribution server acquires a terminal ID that identifies the viewing terminal from the viewing terminal, and stores, onto the decryption key database, in association with the key ID written in the encrypted folder, a date and a time of receiving the viewing request from the viewing terminal, the terminal ID of the viewing terminal, the user ID input into the viewing terminal, and a result of the authentication of the user who accesses the key distribution server with the mobile communication terminal.

11. The encryption key distribution system as set forth in claim 10, wherein
the key distribution server stores, on the user database, an e-mail address of the user in association with the user ID, and
when the authentication of the mobile communication terminal is unsuccessful, the key distribution server reads the e-mail address of the unlocking right owner from the user database by using, as a key, the user ID of the unlocking right owner written in the encrypted folder viewing of which is requested, and sends a message, to the read e-mail address, informing that the viewing request is issued but the authentication is unsuccessful.

12. The encryption key distribution system as set forth in claim 5, wherein
the locking section writes an address of the key distribution server into the encrypted folder, and
the viewing request section establishes the connection with the key distribution server based on the address written in the encrypted folder.

13. The encryption key distribution system as set forth in claim 5, wherein
the key distribution server stores, on the user database, an e-mail address of the mobile communication terminal owned by the user in association with the user ID,
when writing the user ID of the unlocking right owner for the encrypted folder into the encrypted folder, the locking terminal transmits the user ID of the unlocking right owner to the key distribution server, and
the key distribution server reads the e-mail address of the mobile communication terminal owned by the user from the user database by using, as a key, the user ID received from the locking terminal, and sends an e-mail, to the e-mail address of the mobile communication terminal which is read from the user database, informing that the user ID received from the locking terminal is set as the user ID of the unlocking right owner for the encrypted folder.

14. The encryption key distribution system as set forth in claim 13, wherein
the key distribution server sends a message, to the locking terminal, informing that the key distribution server permits the user ID received from the locking terminal to be set as the user ID of the unlocking right owner for the encrypted folder, under a condition that the key distribution server receives a replay e-mail from the e-mail address within a predetermined time limit from a timing of sending the e-mail, and
the locking terminal sets the user ID transmitted to the key distribution server as the user ID of the unlocking right owner for the encrypted folder, under a condition that the locking terminal receives the message informing the permission from the key distribution server.

15. The encryption key distribution system as set forth in claim 13, wherein
the key distribution server provides a download website for an application program which causes the mobile communication terminal to realize a function of accessing the key distribution server and a function of transmitting the authentication data to the key distribution server, and further includes an address of the download website in the e-mail sent to the e-mail address of the mobile communication terminal.

16. The encryption key distribution system as set forth in claim 5, wherein the key distribution server stores, on the user database, an e-mail address of the user in association with the user ID,
when writing the user ID of the unlocking right owner for the encrypted folder into the encrypted folder, the locking terminal transmits the user ID of the unlocking right owner to the key distribution server,
the key distribution server (i) reads the e-mail address of the user from the user database by using, as a key, the user ID received from the locking terminal, (ii) creates a website for the user to decide whether to be registered as the unlocking right owner of the encrypted folder, (iii) sends an e-mail including therein an address of the created website, to the e-mail address read from the user database, and (iv) sends a message, to the locking terminal, informing that the key distribution server permits the user ID received from the locking terminal to be set as the user ID of the unlocking right owner for the encrypted folder, under a condition that the key distribution server detects, on the created website, input of the decision to be registered as the unlocking right owner within a predetermined time limit from a timing of sending the e-mail, and
the locking terminal sets the user ID transmitted to the key distribution server as the user ID of the unlocking right owner for the encrypted folder, under a condition that the locking terminal receives the message informing the permission from the key distribution server.

17. The encryption key distribution system as set forth in claim 5, wherein
the key distribution server (i) provides a download website for an application program which causes the mobile communication terminal to realize a function of accessing the key distribution server and a function of transmitting the authentication data to the key distribution server, (ii) when receiving the viewing request of the encrypted folder from the viewing terminal, reads the e-mail address of the mobile communication terminal owned by the unlocking right owner from the user database by using, as a key, the user ID of the unlocking right owner which is included in the viewing request, and (iii) sends an e-mail, to the read e-mail address, including therein a message informing that a necessary procedure is required to be performed to authenticate the user of the mobile communication terminal as the unlocking right owner of the encrypted folder and an address of the download website.

18. A key distribution server for distributing a decryption key used to decrypt an encrypted folder that is generated by a locking terminal, to a viewing terminal that decrypts the encrypted folder, wherein
when receiving a viewing request of the encrypted folder from the viewing terminal, the key distribution server waits for receiving an access from a mobile communication terminal of a user who is set as an unlocking right owner who is entitled to decrypt the encrypted folder and transmits the decryption key to the viewing terminal under a condition that the key distribution server successfully authenticates the mobile communication terminal.

19. The key distribution server as set forth in claim 18, comprising
a decryption key database that stores thereon the decryption key in association with a key ID that identifies a combination of an encryption key used to encrypt a folder to generate the encrypted folder and the decryption key used to decrypt the encrypted folder which is generated by using the encryption key.

20. The key distribution server as set forth in claim 18, comprising
a user database that stores thereon authentication data unique to the mobile communication terminal which accesses the key distribution server, in association with a user ID of the user of the mobile communication terminal.

21. The key distribution server as set forth in claim 18, comprising
an authentication section that (i) when the key distribution server receives the viewing request of the encrypted folder from the viewing terminal, identifies authentication data unique to the mobile communication terminal owned by the unlocking right owner, based on a user ID of the unlocking right owner, the user ID being included in the viewing request, and (ii) when the key distribution server receives the access from the mobile communication terminal, transmits the decryption key to the viewing terminal, under a condition that the authentication section successfully authenticates the mobile communication terminal based on authentication data received from the mobile communication terminal.

22. The key distribution server as set forth in claim 18, comprising:
a decryption key database that stores thereon the decryption key in association with a key ID that identifies a combination of an encryption key used to encrypt a folder to generate the encrypted folder and the decryption key used to decrypt the encrypted folder which is generated by using the encryption key;
a user database that stores thereon authentication data unique to the mobile communication terminal which accesses the key distribution server, in association with a user ID of the user of the mobile communication terminal; and
an authentication section that (i) when the key distribution server receives the viewing request of the encrypted folder from the viewing terminal, acquires an address of the viewing terminal, (ii) reads the authentication data from the user database, by using, as a key, the user ID of the unlocking right owner who is entitled to decrypt the encrypted folder, the user ID being included in the viewing request, (iii) waits for an access from the mobile communication terminal, (iv) when receiving the access from the mobile communication terminal, receives the authentication data from the mobile communication terminal, (v) compares the authentication data received from the mobile communication terminal with the authentication data read from the user database, (vi) successfully authenticates the mobile communication terminal under a condition that the compared pieces of authentication data match each other, (vii) reads the decryption key from the decryption key database by using, as a key, the key ID that identifies the encryption key used to generate the encrypted folder, the key ID being included in the viewing request, under a condition that the authentication of the mobile communication terminal is successful, and (viii) transmits the read decryption key to the address of the viewing terminal.

23. A locking terminal for generating an encrypted folder by encrypting a folder, comprising
a locking section that, when the locking terminal generates the encrypted folder by encrypting the folder by using an encryption key, writes a user ID of an unlocking right owner who is entitled to decrypt the encrypted folder and a key ID that identifies the encryption key used to generate the encrypted folder, into the encrypted folder.

24. A viewing terminal for unlocking an encrypted folder which is generated by encrypting a folder by using an encryption key, comprising:
a viewing request section that, when the viewing terminal receives a request to view the encrypted folder, reads (i) a user ID of an unlocking right owner who is entitled to decrypt the encrypted folder, (ii) a key ID that identifies the encryption key used to generate the encrypted folder, and (iii) an address of a key distribution server that stores thereon a decryption key corresponding to the key ID, from the encrypted folder, and transmits the read user ID and key ID, to the address of the key distribution server as a viewing request of the encrypted folder; and
an unlocking section that, when receiving the decryption key from the key distribution server, decrypts the encrypted folder the viewing of which is requested, by using the decryption key received from the key distribution server.

25. A locking terminal for generating an encrypted folder by encrypting a folder, and decrypting the encrypted folder by using a decryption key received from a key distribution server, the locking terminal comprising:
a locking section that stores thereon an encryption key used to encrypt the folder, and when generating the encrypted folder by encrypting the folder by using the encryption key, writes a user ID of an unlocking right owner who is entitled to decrypt the encrypted folder and a key ID that identifies the encryption key used to encrypt the folder, into the encrypted folder;
a viewing request section that, when the locking terminal receives a request to view the encrypted folder, reads (i) the user ID of the unlocking right owner who is entitled to decrypt the encrypted folder, (ii) the key ID that identifies the encryption key used to generate the encrypted folder, and (iii) an address of the key distribution server that stores thereon the decryption key corresponding to the key ID, from the encrypted folder, and transmits the read user ID and key ID, to the address of the key distribution server as a viewing request of the encrypted folder; and
an unlocking section, when the locking terminal receives the decryption key from the key distribution server, decrypts the encrypted folder the viewing of which is requested, by using the decryption key received from the key distribution server.

26. An encryption key distribution method for distributing an encryption key by using a system including therein (i) a locking terminal that stores thereon an encryption key used to encrypt a folder, (ii) a key distribution server that stores thereon, in association with the encryption key, a decryption key used to decrypt the encrypted folder which is generated by using the encryption key, (iii) a viewing terminal that unlocks the encrypted folder, and (iv) a mobile communication terminal that is registered on the key distribution server as an authentication key used to authenticate a user, wherein
the locking terminal generates the encrypted folder by encrypting the folder by using the encryption key,
when receiving a request to view the encrypted folder, the viewing terminal transmits a viewing request of the encrypted folder to the key distribution server,
when receiving the viewing request of the encrypted folder from the viewing terminal, the key distribution server transmits the decryption key to the viewing terminal, under a condition that the key distribution server receives an access from the mobile communication terminal owned by the user who is set as an unlocking right owner of the encrypted folder, and
when receiving the decryption key corresponding to the encrypted folder the viewing of which is requested from the key distribution server, the viewing terminal unlocks the encrypted folder by using the decryption key.

27. The encryption key distribution method as set forth in claim 26, wherein
the key distribution server stores (i) on a decryption key database, the decryption key in association with a key ID that identifies a combination of the encryption key used to encrypt the folder and the decryption key used to decrypt the encrypted folder generated by using the encryption key, and (ii) on a user database, authentication data unique to the mobile communication terminal which accesses the key distribution server, in association with a user ID of the user of the mobile communication terminal,
the locking terminal encrypts the folder to generate the encrypted folder, and writes a user ID of the unlocking right owner who is entitled to decrypt the encrypted folder and the key ID that identifies the encryption key used to generate the encrypted folder, into the encrypted folder,
when receiving the request to view the encrypted folder, the viewing terminal establishes a connection with the key distribution server, and transmits, as the viewing request of the encrypted folder, the user ID of the unlocking right owner and the key ID which are written in the encrypted folder, to the key distribution server,
when receiving the viewing request of the encrypted folder from the viewing terminal, the key distribution server (i) acquires an address of the viewing terminal, (ii) reads the authentication data from the user database by using, as a key, the user ID of the unlocking right owner included in the viewing request, and (iii) waits for the access from the mobile communication terminal,
the mobile communication terminal accesses the key distribution server and transmits the authentication data to the key distribution server,
when receiving the access from the mobile communication terminal, the key distribution server (I) receives the authentication data from the mobile communication terminal, (II) compares the authentication data received from the mobile communication terminal with the authentication data read from the user database, (III) successfully authenticates the mobile communication terminal under a condition that the compared pieces of authentication data match each other, (IV) reads the decryption key from the decryption key database by using, as a key, the key ID included in the viewing request, under a condition that the authentication of the mobile communication terminal is successful, and (V) transmits the read decryption key to the address of the viewing terminal, and
the viewing terminal decrypts the encrypted folder the viewing of which is requested, by using the decryption key received from the key distribution server.

28. A computer-readable medium storing thereon a program for a key distribution server for distributing a decryption key used to decrypt an encrypted folder that is generated by a locking terminal, to a viewing terminal that decrypts the encrypted folder,
the program causing the key distribution server to realize
an authentication function of, when the key distribution server receives a viewing request of the encrypted folder from the viewing terminal, waiting for receiving an access from a mobile communication terminal of an unlocking right owner who is entitled to decrypt the encrypted folder and transmitting the decryption key to the viewing terminal under a condition that the key distribution server successfully authenticates the mobile communication terminal.

29. The medium as set forth in claim 28, wherein
the program causes the key distribution server to further realize:
a decryption key managing function of storing the decryption key in association with a key ID that identifies a combination of an encryption key used to encrypt a folder to generate the encrypted folder and the decryption key used to decrypt the encrypted folder which is generated by using the encryption key; and
a user managing function of storing authentication data unique to the mobile communication terminal which accesses the key distribution server, in association with a user ID of the user of the mobile communication terminal, and
the authentication function includes
a function of (i) when the key distribution server receives the viewing request of the encrypted folder from the viewing terminal, acquiring an address of the viewing terminal, (ii) reading the authentication data, by using, as a key, the user ID of the unlocking right owner who is entitled to decrypt the encrypted folder, the user ID being included in the viewing request, (iii) waiting for an access from the mobile communication terminal, (iv) when the key distribution server receives the access from the mobile communication terminal, receiving the authentication data from the mobile communication terminal, (v) comparing the authentication data received from the mobile communication terminal with the read authentication data, (vi) successfully authenticating the mobile communication terminal under a condition that the compared pieces of authentication data match each other, (vii) reading the decryption key by using, as a key, the key ID that identifies the encryption key used to generate the encrypted folder, the key ID being included in the viewing request, under a condition that the authentication of the mobile communication terminal is successful, and (viii) transmitting the read decryption key to the address of the viewing terminal.

30. A computer-readable medium storing thereon a program for a locking terminal for generating an encrypted folder by encrypting a folder,
the program causing the locking terminal to realize
a locking function of, when the locking terminal generates the encrypted folder by encrypting the folder by using an encryption key, writing a user ID of an unlocking right owner who is entitled to decrypt the encrypted folder and a key ID that identifies the encryption key used to generate the encrypted folder, into the encrypted folder.

31. A computer-readable medium storing thereon a program for a viewing terminal for unlocking an encrypted folder which is generated by encrypting a folder by using an encryption key,
the program causing the viewing terminal to realize
a viewing request function of, when the viewing terminal receives a request to view the encrypted folder, reading (i) a user ID of an unlocking right owner who is entitled to decrypt the encrypted folder, (ii) a key ID that identifies the encryption key used to generate the encrypted folder, and (iii) an address of a key distribution server that stores thereon a decryption key corresponding to the key ID, from the encrypted folder, and transmitting the read user ID and key ID, to the address of the key distribution server as a viewing request of the encrypted folder.

32. A computer-readable medium storing thereon a program for a locking terminal for generating an encrypted folder by encrypting a folder, receiving a decryption key used to decrypt the encrypted folder from a key distribution server, and decrypting the encrypted folder by using the decryption key,
the program causing the locking terminal to realize:
a locking function of storing an encryption key used to encrypt the folder, and when the locking terminal generates the encrypted folder by encrypting the folder by using the encryption key, writing a user ID of an unlocking right owner who is entitled to decrypt the encrypted folder and a key ID that identifies the encryption key used to encrypt the folder, into the encrypted folder;
a viewing request function of, when the locking terminal receives a request to view the encrypted folder, reading (i) the user ID of the unlocking right owner who is entitled to decrypt the encrypted folder, (ii) the key ID that identifies the encryption key used to generate the encrypted folder, and (iii) an address of the key distribution server that stores thereon the decryption key corresponding to the key ID, from the encrypted folder, and transmitting the read user ID and key ID, to the address of the key distribution server as a viewing request of the encrypted folder; and
an unlocking function of, when the locking terminal receives the decryption key from the key distribution server, decrypting the encrypted folder the viewing of which is requested, by using the decryption key received from the key distribution server.
